(19) United States
(12) Patent Application Publication
(10) Pub. No.: US 2024/0212198 A1
(43) Pub. Date: Jun. 27, 2024

(54) POSITION DETECTION DEVICE, PHYSIQUE DETECTION SYSTEM, AND POSITION DETECTION METHOD

(71) Applicant: Mitsubishi Electric Corporation, Tokyo (JP)

(72) Inventors: Yayoi HAYASHI, Tokyo (JP); Takumi TAKEI, Tokyo (JP)

(73) Assignee: Mitsubishi Electric Corporation, Tokyo (JP)

(21) Appl. No.: 18/288,576

(22) PCT Filed: May 10, 2021
(86) PCT No.: PCT/JP2021/017626

§ 371 Date: Oct. 27, 2023

(51) Int. Cl. G06T 7/73

(52) U.S. Cl. CPC G06T 7/73; G06T 2207/30196; G06T 2207/30268

(57) ABSTRACT

A position detection device includes processing circuitry configured to detect, on a basis of a captured image captured by a camera, a target feature point corresponding to a part of a body of a person in the captured image; calculate, on a basis of a position of the target feature point on the captured image having been detected, a feature point position angle indicating an angle of a straight line connecting the camera and the target feature point with respect to an imaging axis of the camera; detect a first distance from a distance measuring sensor to the target feature point on a basis of sensor information acquired by the distance measuring sensor; and specify a three-dimensional position of the target feature point on a basis of the calculated feature point position angle and the detected first distance.

### TECHNICAL FIELD

The present disclosure relates to a position detection device, a physique detection system, and a position detection method.

### BACKGROUND ART

Conventionally, there is known a technique of detecting feature points in an image obtained by imaging a region including a person and specifying a three-dimensional position of the person on the basis of the detected feature points.

For example, Patent Literature 1 discloses a method for extracting feature points in a region corresponding to a face in an image obtained by imaging a region corresponding to the face of an occupant in a vehicle, and estimating a three-dimensional position of the head of the occupant on the basis of an inter-feature point distance based on the extracted feature points and an inter-reference feature point distance. In the method, the value of the inter-reference feature point distance is a value set on the basis of statistics of actual measurement values for a plurality of humans, a value calculated by guiding the position of the head of the occupant to a predetermined position when the occupant gets on the vehicle, or a value calculated at timing when the position of the head of the occupant is highly likely to be at the predetermined position.

### CITATION LIST

### Patent Literatures

Patent Literature 1: WO 2019/163124

### SUMMARY OF INVENTION

### Technical Problem

In the method for estimating a three-dimensional position of a person in the related art as disclosed in Patent Literature 1, an inter-reference feature point distance is essential for estimating the three-dimensional position, and there is a problem that the three-dimensional position of the person may be erroneously estimated when the inter-reference feature point distance is not appropriately set.

The present disclosure has been made to solve the problems as described above, and an object thereof is to provide a position detection device capable of specifying a three-dimensional position of a person with higher accuracy than in the related art in which a three-dimensional position of a person is estimated by using an inter-reference feature point distance as an essential factor.

### Solution to Problem

A position detection device of the present disclosure includes a feature point detecting unit to detect, on the basis of a captured image captured by a camera, a target feature point corresponding to a part of a body of a person in the captured image, an angle calculating unit to calculate, on the basis of a position of the target feature point on the captured image detected by the feature point detecting unit, a feature point position angle indicating an angle of a straight line connecting the camera and the target feature point with respect to an imaging axis of the camera, a distance detecting unit to detect a first distance from a distance measuring sensor to the target feature point on the basis of sensor information acquired by the distance measuring sensor, and a position specifying unit to specify a three-dimensional position of the target feature point on the basis of the feature point position angle calculated by the angle calculating unit and the first distance detected by the distance detecting unit.

### Advantageous Effects of Invention

According to the present disclosure, since the position detection device is configured as described above, the three-dimensional position of a person can be specified with higher accuracy than in the related art in which the three-dimensional position of a person is estimated by using an inter-reference feature point distance as an essential factor.

### BRIEF DESCRIPTION OF DRAWINGS

FIG. 1 is a diagram illustrating a configuration example of a position detection device according to a first embodiment.

FIG. 2 is a diagram illustrating an example of an installation position and a direction of a camera mounted on a vehicle and an example of an installation position and a direction of a distance measuring sensor mounted on the vehicle in the first embodiment.

FIG. 3 is a diagram illustrating another example of an installation position and a direction of the camera mounted on the vehicle and another example of an installation position and a direction of the distance measuring sensor mounted on the vehicle in the first embodiment.

FIG. 4 is a diagram for describing an example of a feature point position angle calculated by an angle calculating unit and a method of calculating the feature point position angle by the angle calculating unit in the first embodiment, in which FIG. 4A is a diagram for describing an example of an imaging field angle and the feature point position angle of the camera with respect to a horizontal direction, FIG. 4B is a diagram for describing an example of an imaging field angle and the feature point position angle of the camera with respect to a vertical direction, and FIG. 4C is a diagram illustrating a captured image captured by the camera.

FIG. 5 is a diagram for describing an example of a method for specifying a three-dimensional position of a target feature point by a position specifying unit in the first embodiment, in which FIG. 5A is a diagram illustrating an imaging situation of the camera and a moving object detection situation of the distance measuring sensor when a vehicle interior is viewed from above, and FIG. 5B is a diagram illustrating an imaging situation of the camera and a moving object detection situation of the distance measuring sensor when the vehicle interior is viewed from a left side surface.

FIG. 6 is a flowchart for describing an operation of the position detection device according to the first embodiment.

FIGS. 7A and 7B are diagrams illustrating an example of a hardware configuration of the position detection device according to the first embodiment.

FIG. 8 is a diagram illustrating a configuration example of a position detection device according to a second embodiment.

FIG. 9 is a diagram for describing an example of a method for determining a post-determination distance by the position specifying unit in the second embodiment, in which FIG. 9A is a diagram illustrating a relationship between a detection result of a radio wave sensor and distance resolution. FIGS. 9B, 9C, and 9D are diagrams illustrating post-determination distances determined by the position specifying unit using a second distance.

FIG. 10 is a flowchart for describing the operation of the position detection device according to the second embodiment.

FIG. 11 is a diagram illustrating a configuration example of a position detection device according to a third embodiment.

FIG. 12 is a flowchart for describing the operation of the position detection device according to the third embodiment.

FIG. 13 is a diagram illustrating a configuration example of a position detection device according to a fourth embodiment.

FIGS. 14A and 14B are diagrams for describing an example of a method in which a distance estimating unit sets an inter-reference feature point distance and estimates a second distance using the set inter-reference feature point distance in the fourth embodiment.

FIG. 15 is a flowchart for describing the operation of the position detection device according to the fourth embodiment.

FIG. 16 is a flowchart for describing the operation of a physique detection device in a case where the physique determination is performed when it is determined that the occupant is in a normal sitting state in a physique detection system according to the first embodiment to the fourth embodiment.

### DESCRIPTION OF EMBODIMENTS

Hereinafter, modes for carrying out the present disclosure will be described with reference to the accompanying drawings.

### First Embodiment

A position detection device according to a first embodiment specifies a three-dimensional position of a person on the basis of a captured image captured by a camera and information sensed by a distance measuring sensor. In the first embodiment, the position of a person is represented by the position of a predetermined region of the body of the person. The region of the body of a person is represented by feature points associated with the region. That is, the three-dimensional position of a person is represented by the three-dimensional position of a feature point corresponding to the region of the body of the person. In the first embodiment, as an example, the position of a person is indicated by the position of the head of the person. Which point of the head of a person is set as the feature point corresponding to the position of the head of the person is determined in advance.

In the first embodiment, a feature point associated with the region of the body of a person indicating a position of the person is referred to as a “target feature point”.

Further, in the following first embodiment, as an example, a person whose three-dimensional position is to be specified by the position detection device is an occupant seated on a driver's seat or a passenger seat of a vehicle. In the following first embodiment, an occupant in a driver's seat or a passenger seat is also simply referred to as an “occupant”.

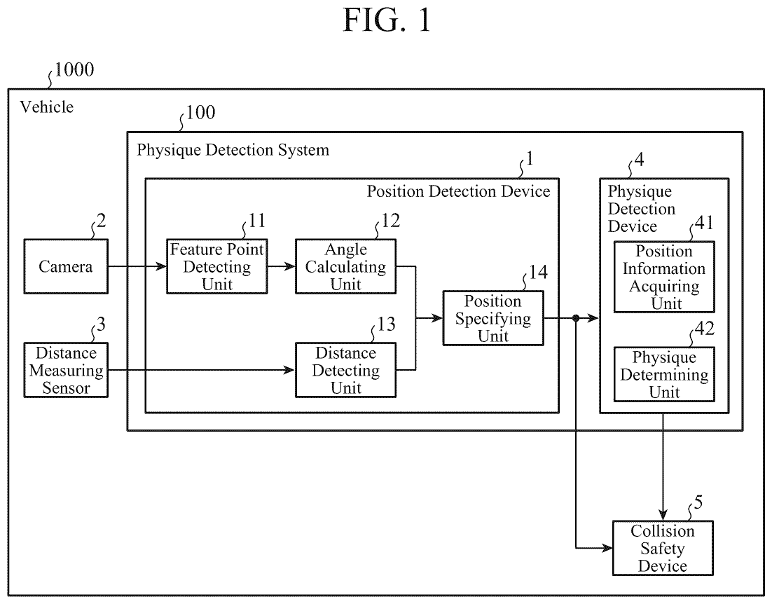

FIG. 1 is a diagram illustrating a configuration example of a position detection device 1 according to the first embodiment.

The position detection device 1 is mounted on a vehicle 1000 and is connected to a camera 2, a distance measuring sensor 3, and a physique detection device 4.

The camera 2 includes a visible light camera or an infrared camera mounted on the vehicle 1000. The camera 2 may be shared with, for example, what is called a “Driver Monitoring System (DMS)”. The camera 2 has an imaging field angle that enables imaging of a range including an occupant seated in at least one (hereinafter referred to as a “front seat”) of a driver's seat or a passenger seat of the vehicle 1000. Note that the unit of the imaging field angle is degree.

The camera 2 outputs the captured image (hereinafter referred to as a “captured image”) to the position detection device 1.

The distance measuring sensor 3 includes, for example, a distance measuring sensor capable of measuring a distance to a moving object, such as a time of flight (TOF) sensor, a radio wave sensor, or an ultrasonic sensor mounted on the vehicle 1000. The distance measuring sensor 3 acquires information regarding a distance to a moving object present in the vehicle interior (hereinafter referred to as “sensor information”). The distance measuring sensor 3 outputs the acquired sensor information to the position detection device 1.

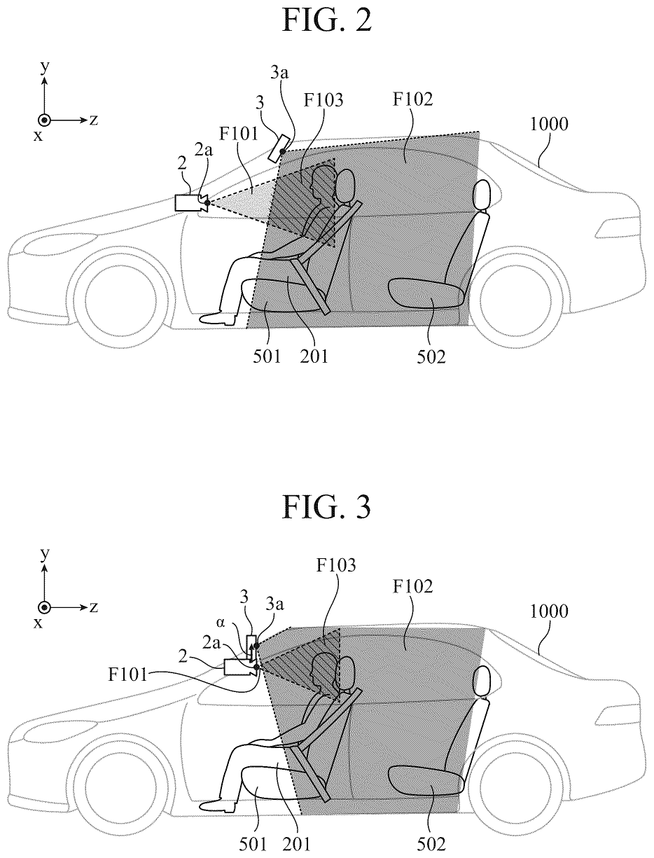

Here, FIG. 2 is a diagram illustrating an example of an installation position and direction of the camera 2 mounted on the vehicle 1000 and an example of the installation position and direction of the distance measuring sensor 3 mounted on the vehicle 1000 in the first embodiment.

Note that FIG. 2 is a diagram of the vehicle 1000 as viewed from a left side in a traveling direction of the vehicle 1000, and a front seat is denoted by 501 and a back seat is denoted by 502.

As illustrated in FIG. 2, for example, the camera 2 is installed on a dashboard in a direction in which it is possible to capture an image of a real space in which the occupant seated on the front seat is assumed to be present, that is, a real space in which a target feature point is assumed to be present.

In the first embodiment, the position of camera 2 is represented by a point at which a lens surface and an imaging axis intersect. In the first embodiment, the imaging axis refers to an optical axis of an imaging unit, that is, an optical system in the camera 2.

In FIG. 2, the position of the camera 2 is set to the position indicated by 2a for convenience.

In addition, for example, the distance measuring sensor 3 is installed in an overhead console in a direction in which it is possible to sense the real space in which the occupant seated on the front seat is assumed to be present, that is, the real space in which the target feature point is assumed to be present. Since the distance measuring sensor 3 is installed in the overhead console, the influence of multipath noise can be suppressed, and the occupant (indicated by 201 in FIG. 2) can be detected with higher accuracy.

In the first embodiment, the position of the distance measuring sensor 3 is represented by the center of the distance measuring sensor 3 determined by the relationship with a sensing range of the distance measuring sensor 3.

In FIG. 2, the position of the distance measuring sensor 3 is set to the position indicated by 3a for convenience.

The camera 2 and the distance measuring sensor 3 are installed so that an imaging range (indicated by F101 in FIG. 2) of the camera 2 and a sensing range (indicated by F102 in FIG. 2) of the distance measuring sensor 3 overlap each other. Note that, in FIG. 2, the region where the imaging range of the camera 2 and the sensing range of the distance measuring sensor 3 overlap is indicated by F103.

In the first embodiment, a coordinate system of the camera 2 in the three-dimensional space and a coordinate system of the distance measuring sensor 3 in the three-dimensional space are represented by the same coordinate system. That is, the X axis, the Y axis, and the Z axis in the coordinate system of the camera 2 are common to the X axis, the Y axis, and the Z axis in the coordinate system of the distance measuring sensor 3. In the first embodiment, coordinates of the position of the camera 2 are set to (0,0,0) in the coordinate system in the three-dimensional space common to the camera 2 and the distance measuring sensor 3.

In the following first embodiment, as an example, it is assumed that the camera 2 and the distance measuring sensor 3 are installed at positions as illustrated in FIG. 3.

FIG. 3 is a diagram of the vehicle 1000 as viewed from the left side in the traveling direction of the vehicle 1000, and the front seat is denoted by 501 and the back seat is denoted by 502, as in FIG. 2. Further, in FIG. 3, an occupant is indicated by 201. Further, for convenience, in FIG. 3, the position of the camera 2 is set to the position indicated by 2a, and the position of the distance measuring sensor 3 is set to the position indicated by 3a.

In FIG. 3, the distance measuring sensor 3 is installed so that the head of the occupant is located closest to the distance measuring sensor 3 among the regions of the body of the occupant. Further, the camera 2 is installed on a dashboard.

In the camera 2 and the distance measuring sensor 3, installation axes in a left-right direction, an up-down direction, and a front-rear direction are equal to installation coordinates in the left-right direction and the front-rear direction. The camera 2 and the distance measuring sensor 3 have different installation coordinates in the vertical direction. Specifically, the distance measuring sensor 3 is installed above the camera 2 by α [m].

The camera 2 and the distance measuring sensor 3 are installed so that the directions thereof coincide with each other and the positions thereof coincide with each other, and thus it is possible to reduce the amount of calculation of processing when the three-dimensional position of the target feature point is specified in the position detection device 1. That is, when the camera 2 and the distance measuring sensor 3 are installed so that the directions thereof coincide with each other and the positions thereof coincide with each other, it can be said that the camera 2 and the distance measuring sensor 3 are installed at optimum positions at which the calculation amount of processing when specifying the three-dimensional position of the target feature point in the position detection device 1 can be minimized. Details of the position detection device 1 will be described later.

Note that, in the first embodiment, the fact that the camera 2 and the distance measuring sensor 3 are installed so that the positions of the camera 2 and the distance measuring sensor 3 coincide with each other means that the camera 2 and the distance measuring sensor 3 are installed so that all of positions in a lateral direction (X-axis direction), positions in a height direction (Y-axis direction), positions in a depth direction (Z-axis direction), and installation inclinations coincide with each other in the three-dimensional space.

Here, at the optimum installation positions of the camera 2 and the distance measuring sensor 3 at which the calculation amount of the processing at the time of specifying the three-dimensional position of the target feature point in the position detection device 1 can be minimized, the position of the camera 2 and the position of the distance measuring sensor 3 do not need to completely coincide, and may substantially coincide within a predetermined allowable range. In addition, at the optimum installation positions of the camera 2 and the distance measuring sensor 3 at which the calculation amount of the processing at the time of specifying the three-dimensional position of the target feature point in the position detection device 1 can be minimized, the direction of the camera 2 and the direction of the distance measuring sensor 3 do not need to completely coincide, and may substantially coincide within a predetermined allowable range.

Note that, in FIGS. 2 and 3, the position of the camera 2 and the position of the distance measuring sensor 3 do not coincide with each other.

In the first embodiment, the camera 2 and the distance measuring sensor 3 may be installed so that at least one of the positions in the lateral direction (X-axis direction), the positions in the height direction (Y-axis direction), the positions in the depth direction (Z-axis direction), or the installation inclinations in the three-dimensional space is the same.

The position detection device 1 specifies the three-dimensional position of the target feature point on the basis of the captured image captured by the camera 2 and the sensor information acquired by the distance measuring sensor 3. That is, the position detection device 1 specifies the three-dimensional position of the target feature point, thereby specifying the three-dimensional position of the occupant.

After specifying the three-dimensional position of the target feature point, the position detection device 1 outputs information (hereinafter referred to as “position information”) related to the three-dimensional position of the target feature point to the physique detection device 4.

The physique detection device 4 is mounted on the vehicle 1000, and determines the physique of the occupant on the basis of the position information output from the position detection device 1.

The physique detection device 4 includes a position information acquiring unit 41 and a physique determining unit 42.

The position information acquiring unit 41 acquires position information from the position detection device 1.

The physique determining unit 42 determines the physique of the occupant on the basis of the position information acquired by the position information acquiring unit 41.

It is sufficient if the physique determining unit 42 determines the physique of the occupant using a well-known technique of determining the physique of a person from information indicating the position of the person, a detailed description of a method of determining the physique of the occupant by the physique determining unit 42 is omitted.

The position detection device 1 and the physique detection device 4 constitute a physique detection system 100.

The information regarding the physique of the occupant determined by the physique detection device 4 is output to a collision safety device 5 mounted on the vehicle 1000.

The collision safety device 5 controls an airbag (not illustrated), a seat belt pretensioner (not illustrated), or the like mounted on the vehicle 1000 according to the physique of the occupant determined by the physique detection device 4.

The airbag, the seat belt pretensioner, or the like needs to be controlled in consideration of the physique of the occupant. For example, the airbag needs to be controlled so as not to damage the occupant with explosive force of the airbag on the basis of the distance between the airbag and the occupant corresponding to a physique of the occupant when the airbag is activated. In addition, for example, the seat belt pretensioner needs to be controlled in consideration of the position of the neck according to the occupant's physique so that the seat belt does not tighten the neck of the occupant when the seat belt pretensioner operates. Thus, the physique detection device 4 is required to appropriately determine the physique of the occupant so that the collision safety device 5 appropriately operates the control function of the airbag, the seat belt pretensioner, or the like. That is, the position detection device 1 is required to accurately specify the position of the occupant which is a basis of determination of the physique of the occupant. The position detection device 1 according to the first embodiment can specify the position of the occupant with high accuracy.

Note that the collision safety device 5 may acquire the position information of the occupant output by the position detection device 1 and control the airbag, the seat belt pretensioner, or the like.

The position detection device 1 according to the first embodiment will be described.

As illustrated in FIG. 1, the position detection device 1 includes a feature point detecting unit 11, an angle calculating unit 12, a distance detecting unit 13, and a position specifying unit 14.

The feature point detecting unit 11 acquires a captured image from the camera 2, and detects a target feature point in the captured image on the basis of the captured image captured by the camera 2. Here, the feature point detecting unit 11 detects the target feature point corresponding to the head of the occupant in the captured image.

Note that the feature point detecting unit 11 can detect a plurality of feature points. For example, the feature point detecting unit 11 may detect feature points indicating parts of the face such as the eyes and the nose together, or may detect feature points indicating parts of the body such as the neck and the shoulder together.

The feature point detecting unit 11 is only required to detect a feature point in a captured image using a known technique of detecting a feature point of a person from the captured image, and thus a detailed description of a method of detecting a feature point by the feature point detecting unit 11 is omitted. The feature points in the captured image are represented by coordinates on the captured image.

The feature point detecting unit 11 outputs information regarding the detected target feature point (hereinafter referred to as “target feature point information”) to the angle calculating unit 12.

The angle calculating unit 12 calculates a “feature point position angle” indicating an angle of a straight line connecting the camera 2 and the target feature point with respect to the imaging axis of the camera 2 on the basis of the position of the target feature point detected by the feature point detecting unit 11 on the captured image.

More specifically, the angle calculating unit 12 calculates a feature point position angle indicating an angle in a direction from the camera 2 toward the three-dimensional position of the target feature point with respect to the direction of the imaging axis of the camera 2.

Here, the target feature point detected by the above-described feature point detecting unit 11 and the feature point position angle calculated by the angle calculating unit 12 will be described with reference to the drawings.

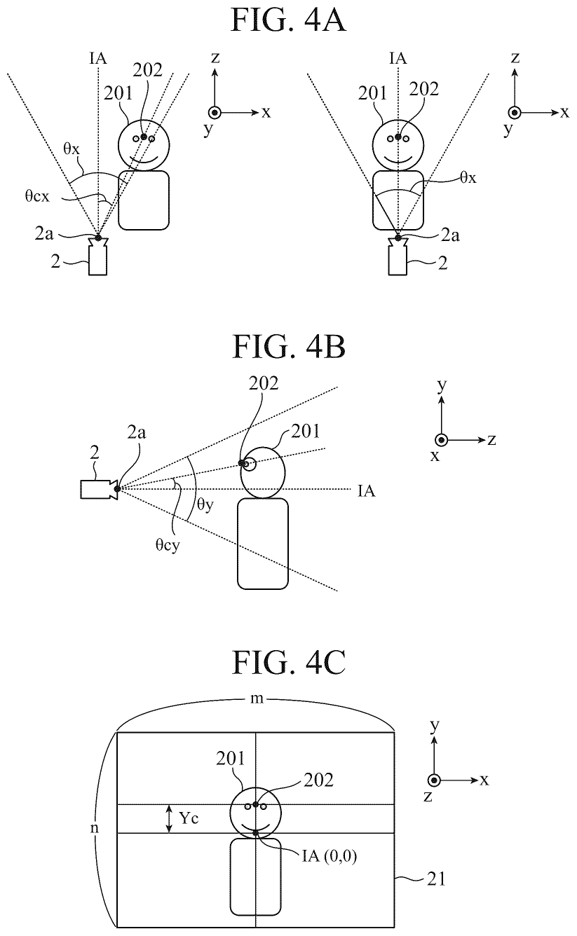

FIG. 4 is a diagram for describing an example of feature point position angles θcx and θcy calculated by the angle calculating unit 12 and a method of calculating the feature point position angles θcx and θcy by the angle calculating unit 12 in the first embodiment.

In FIG. 4, the occupant is indicated by 201, and the head position of the occupant, that is, the position of the feature point corresponding to the head of the occupant is indicated by 202.

FIG. 4A is a diagram for describing an example of an imaging field angle θx and a feature point position angle θcx of the camera 2 with respect to the horizontal direction, FIG. 4B is a diagram for describing an example of an imaging field angle θy and a feature point position angle θcy of the camera 2 with respect to the vertical direction, and FIG. 4C is a diagram illustrating a captured image captured by the camera 2.

As described above, the camera 2 has the imaging field angles θx and θy.

Here, as illustrated in FIG. 4A, θx is an imaging field angle with respect to the horizontal direction (in FIG. 4, a direction along a virtual plane defined by the x axis and the z axis).

As illustrated in the left diagram of FIG. 4A, θcx is a feature point position angle with respect to the horizontal direction. Note that the left diagram of FIG. 4A is illustrated for ease of understanding of θcx, but here, for example, as illustrated in the right diagram of FIG. 4A, the feature point position angle θcx=0 [degrees] is set. That is, it is assumed that the directions in the horizontal direction of the straight line connecting the camera 2 and the target feature point coincides with the imaging axis (indicated by IA in FIG. 4) of the camera 2.

As illustrated in FIG. 4B, θy is an imaging field angle with respect to the vertical direction (in FIG. 4, a direction along a virtual plane defined by the y axis and the z axis).

As illustrated in FIG. 4B, θcy is a feature point position angle with respect to the vertical direction.

Note that the unit of the feature point position angles θcx and θcy is degree.

In a case where there is a target feature point at a position where the feature point position angles θcx and θcy become angles as illustrated in the right diagram of FIG. 4A and FIG. 4B, the captured image in which the target feature point is captured becomes a captured image indicated by 21 in FIG. 4C.

The feature point detecting unit 11 detects the target feature point on the captured image as indicated by 21 in FIG. 4C. Here, it is assumed that the target feature point detected by the feature point detecting unit 11 is represented by, for example, coordinates (Xc, Yc).

The angle calculating unit 12 calculates the feature point position angles θcx and θcy with respect to the imaging axis of the camera 2 on the basis of a position on the captured image of the target feature point represented by the coordinates (Xc, Yc) detected by the feature point detecting unit 11. When calculating the feature point position angles θcx and θcy, the angle calculating unit 12 assumes that coordinates of a position corresponding to the imaging axis of the camera 2 in the captured image, that is, position coordinates of the central portion on the captured image are set to (0, 0) as illustrated in FIG. 4C.

Specifically, the angle calculating unit 12 stores in advance values of the imaging field angles θx and θy, a resolution value (indicated by m in FIG. 4C) in a first axis direction (x-axis direction in FIG. 4) in the captured image, and a resolution value (indicated by n in FIG. 4C) in a second axis direction (y-axis direction in FIG. 4) in the captured image. Note that the unit of resolution is pixel (px).

The angle calculating unit 12 calculates the feature point position angles θcx and θcy by the following Expressions (1) and (2) on the basis of the coordinates (Xc, Yc) of the position of the target feature point detected by the feature point detecting unit 11.

$$Xc : tan θ cx = ( m / 2 ) : tan ( θ x / 2 ) \qquad ( 1 )$$

$$Yc : tan θ cy = ( n / 2 ) : tan ( θ y / 2 ) \qquad ( 2 )$$

It can be said that the three-dimensional position coordinates of the target feature point are on a straight line of the following Expression (3).

$$Z = \frac{X}{tan θ cx} = \frac{Y}{tan θ cy} \qquad ( 3 )$$

Note that, here, the coordinates on the captured image (Xc, Yc)=(0, Yc), and the feature point position angle θcx=0 (degrees).

The angle calculating unit 12 outputs information regarding the calculated feature point position angle, more specifically, information of Expression (3) obtained from the calculated feature point position angle, to the position specifying unit 14.

The distance detecting unit 13 acquires sensor information from the distance measuring sensor 3 and detects an occupant on the basis of the acquired sensor information. Specifically, the distance detecting unit 13 detects the distance (hereinafter referred to as a “first distance”) from the distance measuring sensor 3 to the target feature point on the basis of the sensor information. Note that the distance detecting unit 13 is only required to detect the occupant using a known technique of detecting a moving object from the sensor information, and thus a detailed description of a method of detecting the occupant by the distance detecting unit 13 is omitted.

The distance detecting unit 13 outputs information regarding the detected first distance (hereinafter referred to as “sensor distance information”) to position specifying unit 14.

The position specifying unit 14 specifies the three-dimensional position of the target feature point on the basis of the information regarding the feature point position angle calculated by the angle calculating unit 12, in other words, the information of Expression (3) and the first distance detected by the distance detecting unit 13.

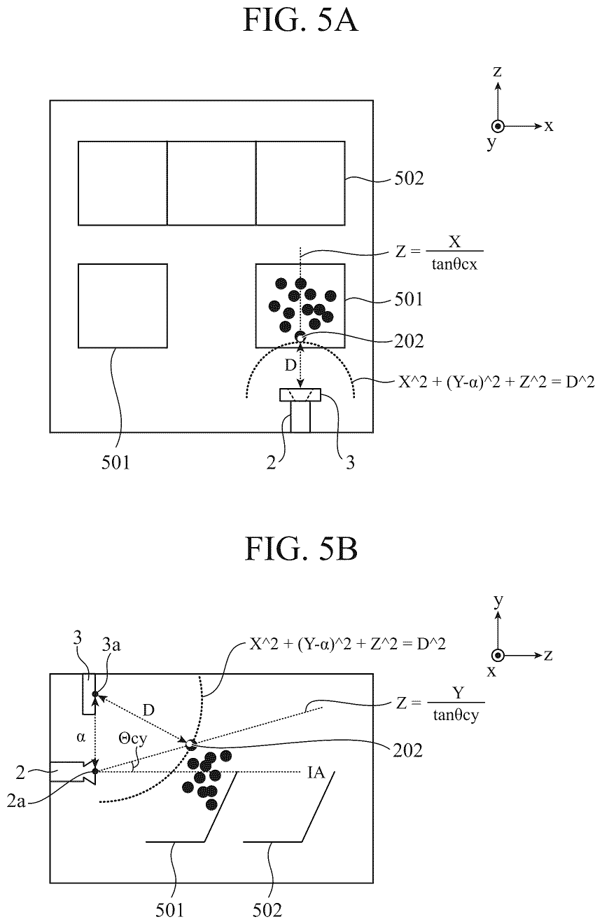

FIG. 5 is a diagram for describing an example of a method for specifying a three-dimensional position of a target feature point by the position specifying unit 14 in the first embodiment. FIG. 5A is a diagram illustrating an imaging situation of the camera 2 and a moving object detection situation of the distance measuring sensor 3 when the vehicle interior is viewed from above, and FIG. 5B is a diagram illustrating an imaging situation of the camera 2 and a moving object detection situation of the distance measuring sensor 3 when the vehicle interior is viewed from a left side surface. Note that the camera 2 and the distance measuring sensor 3 are installed at the installation positions illustrated in FIG. 3. 2a and 3a in FIG. 5B indicate the position of the camera 2 and the position of the distance measuring sensor 3, respectively, and IA in FIG. 5B indicates the imaging axis of the camera 2. In addition, in FIG. 5, the front seat 501 and the back seat 502 are illustrated in a simplified manner.

Further, the positional relationship between the camera 2 and the target feature point is the positional relationship illustrated in the right diagram of FIG. 4A and FIG. 5B.

Now, since the distance measuring sensor 3 is installed so that the position of the head of the occupant is closest among the regions of the body of the occupant as viewed from the distance measuring sensor 3, a point indicated by 202 in FIG. 5 is a point indicating the head of the occupant, in other words, a target feature point. The distance detecting unit 13 detects a point indicated by 202 in FIG. 5 as a target feature point. Then, the distance detecting unit 13 detects the distance from the distance measuring sensor 3 to the target feature point. Here, it is assumed that the first distance to the target feature point detected by the distance detecting unit 13 is, for example, D [m].

The information of Expression (3) is output from the angle calculating unit 12 to the position specifying unit 14.

Further, the sensor distance information regarding the first distance is output from the distance detecting unit 13 to the position specifying unit 14. Here, information of the first distance=D [m] is output to the position specifying unit 14.

Since the first distance detected by the distance detecting unit 13 is D [m], the target feature point is on a sphere having a radius D [m] centered on the position of the distance measuring sensor 3. That is, when the center is set to (X0, Y0, Z0), coordinates (X, Y, Z) of the three-dimensional position of the target feature point are expressed as (X−X0)\hat{ }2+(Y−Y0)\hat{ }2+(Z−Z0)\hat{ }2=D\hat{ }2.

Here, in the first embodiment, since the coordinates of the position of the camera 2 are set to (0,0,0) in the coordinate system in the three-dimensional space common to the camera 2 and the distance measuring sensor 3, the coordinates of the position of the distance measuring sensor 3 are (0, α, 0).

Then, the three-dimensional position of the target feature point represented by the coordinates (X, Y, Z) is on a sphere of X\hat{ }2+(Y−α)\hat{ }2+Z\hat{ }2=D\hat{ }2.

The position specifying unit 14 can calculate the coordinates (X, Y, Z) of the three-dimensional position of the target feature point by obtaining an intersection of the straight line represented by Expression (3) and the sphere of X\hat{ }2+(Y−α)\hat{ }2+Z\hat{ }2=D\hat{ }2. The coordinates (X, Y, Z) of the three-dimensional position of the target feature point are coordinates indicating the three-dimensional position of the occupant.

In a case where the distance measuring sensor 3 is a sensor including a plurality of receiving elements, the distance detecting unit 13 can detect not only the distance to the object but also the direction (angle) in which the object is present. Thus, the distance measuring sensor can detect the distance to the object in an angular direction of the feature point captured by the camera 2.

In this case, the position specifying unit 14 may calculate the coordinates (X, Y, Z) of the three-dimensional position of the target feature point from the intersection of two straight lines of the straight line represented by Expression (3) and a straight line including a line segment indicating the distance to the object in an angular direction of the feature point detected by the distance detecting unit 13. Specifically, the position specifying unit 14 is only required to set a distance to the intersection of the two straight lines, which is detected by the distance detecting unit 13 as the distance to the target feature point, and calculate the coordinates (X, Y, Z) of the three-dimensional position of the target feature point.

Therefore, in a case where the distance measuring sensor 3 is a sensor including a plurality of receiving elements, the coordinates (X, Y, Z) of the three-dimensional position of the target feature point can be calculated even when the distance measuring sensor 3 is not installed so that the target feature point (here, the head of the occupant) is closest.

Further, here, the method in which the position specifying unit 14 calculates the three-dimensional position of the target feature point in a case where the positional relationship among the target feature point, the camera 2, and the distance measuring sensor 3 is the positional relationship as illustrated in FIGS. 3, 4, and 5 has been described, but this is merely an example.

Even when the positional relationship among the target feature point, the camera 2, and the distance measuring sensor 3 is a positional relationship other than the positional relationship as in the above-described example, the position specifying unit 14 can similarly calculate the three-dimensional position of the target feature point from the expression of the straight line passing through the position of the camera 2 and the target feature point and the expression of the spherical surface centered on the position of the distance measuring sensor 3 and having the radius of the first distance.

The position specifying unit 14 outputs position information regarding the specified three-dimensional position of the occupant to the physique detection device 4.

An operation of the position detection device 1 according to the first embodiment will be described.

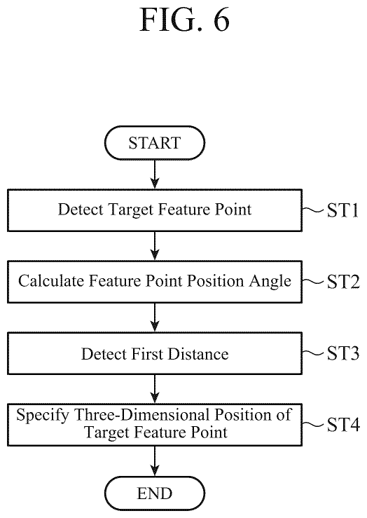

FIG. 6 is a flowchart for describing an operation of the position detection device 1 according to the first embodiment.

The feature point detecting unit 11 acquires a captured image from the camera 2, and detects a target feature point in the captured image on the basis of the captured image captured by the camera 2 (step ST1).

The feature point detecting unit 11 outputs the target feature point information to the angle calculating unit 12.

The angle calculating unit 12 calculates a feature point position angle on the basis of the position on the captured image of the target feature point detected by the feature point detecting unit 11 in step ST1 (step ST2).

The angle calculating unit 12 outputs information regarding the calculated feature point position angle to the position specifying unit 14.

The distance detecting unit 13 acquires sensor information from the distance measuring sensor 3 and detects an occupant on the basis of the acquired sensor information. Specifically, the distance detecting unit 13 detects the first distance on the basis of the sensor information (step ST3).

The distance detecting unit 13 outputs the sensor distance information to the position specifying unit 14.

The position specifying unit 14 specifies the three-dimensional position of the target feature point on the basis of the information regarding the feature point position angle calculated by the angle calculating unit 12 in step ST2 and the first distance detected by the distance detecting unit 13 in step ST3 (step ST4).

The position specifying unit 14 outputs position information related to the specified three-dimensional position of the target occupant to the physique detection device 4.

Note that, in the flowchart illustrated in FIG. 6, the position detection device 1 performs processing in the order of step ST1, step ST2, and step ST3, but this is merely an example.

For example, the position detection device 1 may perform the processing in the order of step ST3, step ST1, and step ST2, or may perform the processing of steps ST1 to ST2 and the processing of step ST3 in parallel.

As described above, the position detection device 1 can specify the three-dimensional position of the target feature point that cannot be directly measured from the captured image captured by the camera 2, in other words, the three-dimensional position of the occupant with high accuracy by using the sensor information by the distance measuring sensor 3.

In the method for estimating the three-dimensional position of a person in the related art as described above, an inter-reference feature point distance is essential to estimate the three-dimensional position, and when the inter-reference feature point distance is not appropriately set, there is a possibility that the three-dimensional position of the person is erroneously estimated.

For example, when the value of the inter-reference feature point distance is set on the basis of statistics of actual measurement values for a plurality of persons, there is a possibility that the three-dimensional position of a person is erroneously specified because the individual difference is not considered. In addition, for example, even when the value of the inter-reference feature point distance is set when the occupant gets on the vehicle in consideration of individual differences, the three-dimensional position of the person cannot be specified while the value of the inter-reference feature point distance is not set. Further, when the position of the head of the occupant is guided to a predetermined position to set the value of the inter-reference feature point distance, inconvenience for the occupant occurs.

On the other hand, as described above, the position detection device 1 according to the first embodiment can specify the three-dimensional position of the target feature point that cannot be directly measured from the captured image captured by the camera 2, in other words, the three-dimensional position of the occupant with high accuracy by using the sensor information by the distance measuring sensor 3. That is, the position detection device 1 can specify the three-dimensional position of the person with higher accuracy than the related art in which the three-dimensional position of the person is estimated by using the inter-reference feature point distance as an essential factor.

Note that when the position detection device 1 has, for example, the distance measuring sensor 3 as a radio wave sensor, and detects the three-dimensional position of the target feature point using sensor information acquired from the radio wave sensor, the position detection device 1 can grasp the three-dimensional position of the occupant with higher accuracy as compared with a case where the three-dimensional position of the target feature point is detected using the sensor information acquired from the distance measuring sensor 3 of a type other than the radio wave sensor. This is because the radio wave sensor can detect the occupant through a shielding object even when a shielding object such as a bulky outerwear, hat, or baggage is present in front of the occupant, and can detect the front-rear position of the occupant with high accuracy.

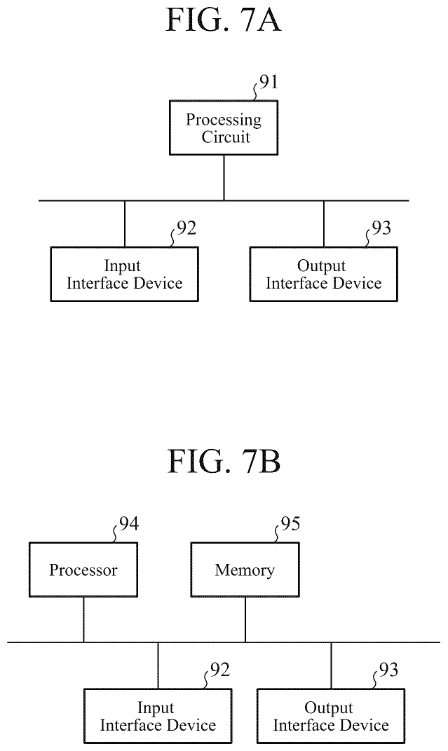

FIGS. 7A and 7B are diagrams illustrating an example of a hardware configuration of the position detection device 1 according to the first embodiment.

In the first embodiment, the functions of the feature point detecting unit 11, the angle calculating unit 12, the distance detecting unit 13, and the position specifying unit 14 are implemented by a processing circuit 91. That is, the position detection device 1 includes the processing circuit 91 for performing control to detect the three-dimensional position of the person from the captured image captured by the camera 2 and the sensor information acquired by the distance measuring sensor 3.

The processing circuit 91 may be dedicated hardware as illustrated in FIG. 7A or a processor 94 that executes a program stored in a memory as illustrated in FIG. 7B.

In a case where the processing circuit 91 is dedicated hardware, the processing circuit 91 corresponds to, for example, a single circuit, a composite circuit, a programmed processor, a parallel programmed processor, an application specific integrated circuit (ASIC), a field-programmable gate array (FPGA), or a combination thereof.

When the processing circuit is the processor 94, the functions of the feature point detecting unit 11, the angle calculating unit 12, the distance detecting unit 13, and the position specifying unit 14 are implemented by software, firmware, or a combination of software and firmware. Software or firmware is described as a program and stored in a memory 95. The processor 94 executes the functions of the feature point detecting unit 11, the angle calculating unit 12, the distance detecting unit 13, and the position specifying unit 14 by reading and executing the program stored in the memory 95. That is, the position detection device 1 includes the memory 95 for storing a program that results in execution of steps ST1 to ST4 of FIG. 6 described above when executed by the processor 94. Further, it can also be said that the program stored in the memory 95 causes a computer to execute a procedure or a method performed in the feature point detecting unit 11, the angle calculating unit 12, the distance detecting unit 13, and the position specifying unit 14. Here, the memory 95 corresponds to, for example, a nonvolatile or volatile semiconductor memory such as a RAM, a read only memory (ROM), a flash memory, an erasable programmable read only memory (EPROM), or an electrically erasable programmable read-only memory (EEPROM), or a magnetic disk, a flexible disk, an optical disk, a compact disk, a mini disk, a digital versatile disc (DVD), or the like.

Note that a part of the functions of the feature point detecting unit 11, the angle calculating unit 12, the distance detecting unit 13, and the position specifying unit 14 may be implemented by dedicated hardware and partially implemented by software or firmware. For example, the functions of the feature point detecting unit 11 and the distance detecting unit 13 can be implemented by the processing circuit 91 as dedicated hardware, and the functions of the angle calculating unit 12 and the position specifying unit 14 can be implemented by the processor 94 reading and executing the program stored in the memory 95.

In addition, the position detection device 1 includes an input interface device 92 and an output interface device 93 that perform wired communication or wireless communication with devices such as the camera 2, the distance measuring sensor 3, the physique detection device 4, or the collision safety device 5.

Note that, in the first embodiment described above, the position of the occupant is indicated by the position of the head of the occupant, but this is merely an example. The position of the occupant may be indicated by a plurality of regions of the body of the occupant. That is, there may be a plurality of target feature points. The position detection device 1 can also detect three-dimensional positions of a plurality of target feature points.

In this case, in the position detection device 1, the distance detecting unit 13 detects each of first distances of the plurality of target feature points. For example, it is assumed that the distance measuring sensor 3 including a receiving antenna having a plurality of receiving antenna elements that receives a reflected wave of a radio wave radiated from a transmitting antenna and have positions different from each other in the width direction of the vehicle 1000 is installed in the vehicle 1000, and the distance detecting unit 13 is only required to detect the first distances of the plurality of target feature points on the basis of sensor information acquired from the distance measuring sensor 3. More specifically, for example, the distance detecting unit 13 acquires the captured image from the camera 2, specifies a direction in which each target feature point is present on the basis of the captured image, and the distance measuring sensor 3 can obtain the arrival direction of the reflected wave by analyzing reception waves by the plurality of antennas, so that a distance to the moving object in the direction in which each target feature point is present can be regarded as the distance to each target feature point.

In the first embodiment described above, as an example, the occupant whose three-dimensional position is to be specified is an occupant seated in the driver's seat or the passenger seat of the vehicle 1000, but this is merely an example. The occupant whose three-dimensional position is to be specified may be an occupant in the back seat. The position detection device 1 can also specify the three-dimensional position of the occupant in the back seat. That is, the position detection device 1 can also specify the three-dimensional position of the target feature point corresponding to a region of the body indicating the position of the occupant in the back seat.

Further, in the first embodiment described above, one camera 2 and one distance measuring sensor 3 are installed in the vehicle interior, but this is merely an example. A plurality of cameras 2 may be installed in the vehicle interior, and a plurality of distance measuring sensors 3 may be installed in the vehicle interior.

The camera 2 and the distance measuring sensor 3 may be installed so that the imaging range of the camera 2 and the sensing range of the distance measuring sensor 3 overlap with each other.

Further, in the first embodiment described above, the position detection device 1 is an in-vehicle device mounted on the vehicle 1000, and the feature point detecting unit 11, the angle calculating unit 12, the distance detecting unit 13, and the position specifying unit 14 are included in the in-vehicle device. Not limited to this, an in-vehicle device and a server may constitute a position detection system in which a part of the feature point detecting unit 11, the angle calculating unit 12, the distance detecting unit 13, and the position specifying unit 14 is included in the in-vehicle device of the vehicle, and the rest is provided in the server connected to the in-vehicle device via a network.

In addition, all of the feature point detecting unit 11, the angle calculating unit 12, the distance detecting unit 13, and the position specifying unit 14 may be included in the server.

In addition, in the first embodiment described above, the physique detection device 4 is an in-vehicle device mounted on the vehicle 1000, and the position information acquiring unit 41 and the physique determining unit 42 are provided in the in-vehicle device, but this is merely an example. A part of the position information acquiring unit 41 and the physique determining unit 42 may be included in the in-vehicle device, others may be included in the server, or the position information acquiring unit 41 and the physique determining unit 42 may be included in the server.

In addition, the collision safety device 5 may be provided in the server.

Further, in the first embodiment described above, the person whose three-dimensional position is to be detected by the position detection device 1 is an occupant of the vehicle 1000, but this is merely an example. The position detection device 1 can detect a three-dimensional position of an occupant in various vehicles. Further, the position detection device 1 can detect the three-dimensional position of not only an occupant of a vehicle but also a person in a real space, such as a person in a room.

As described above, according to the first embodiment, the position detection device 1 includes the feature point detecting unit 11 to detect, on the basis of a captured image captured by the camera 2, a target feature point corresponding to a region of the body of a person in the captured image, the angle calculating unit 12 to calculate, on the basis of a position of the target feature point on the captured image detected by the feature point detecting unit 11, a feature point position angle indicating an angle of a straight line connecting the camera 2 and the target feature point with respect to the imaging axis of the camera 2, the distance detecting unit 13 to detect the first distance from the distance measuring sensor 3 to the target feature point on the basis of sensor information acquired by the distance measuring sensor 3, and the position specifying unit 14 to specify the three-dimensional position of the target feature point on the basis of the feature point position angle calculated by the angle calculating unit 12 and the first distance detected by the distance detecting unit 13. Thus, the position detection device 1 can specify the three-dimensional position of the person with higher accuracy than the related art in which the three-dimensional position of the person is estimated by using the inter-reference feature point distance as an essential factor.

### Second Embodiment

In a second embodiment, an embodiment will be described in which the distance measuring sensor is a radio wave sensor, and the three-dimensional position of a person is specified with higher accuracy by considering the distance to the person estimated on the basis of the captured image.

Also in the following second embodiment, as in the first embodiment, as an example, a person whose three-dimensional position is to be specified is an occupant seated in a driver's seat or a passenger seat of a vehicle, and the position of the occupant is indicated by the position of the head of the occupant. In addition, it is assumed that the camera and the distance measuring sensor are installed at positions as described with reference to FIG. 3 in the first embodiment.

On the other hand, in the second embodiment, it is assumed that the distance measuring sensor is a radio wave sensor. The radio wave sensor can detect the occupant through a shielding object, and can detect the front-rear position of the occupant with high accuracy.

The radio wave sensor is detected at intervals of distance resolution. For example, when distance resolution is 2 [cm], even when the position of the occupant is 10 [cm] or 10.5 [cm] or 11 [cm], the same value is detected from the radio wave sensor. This distance resolution is inversely proportional to the use bandwidth, and for example, in a case of a radio wave sensor in the 60 GHz band, the use bandwidth is 7 GHZ, and the distance resolution is about 2.14 cm.

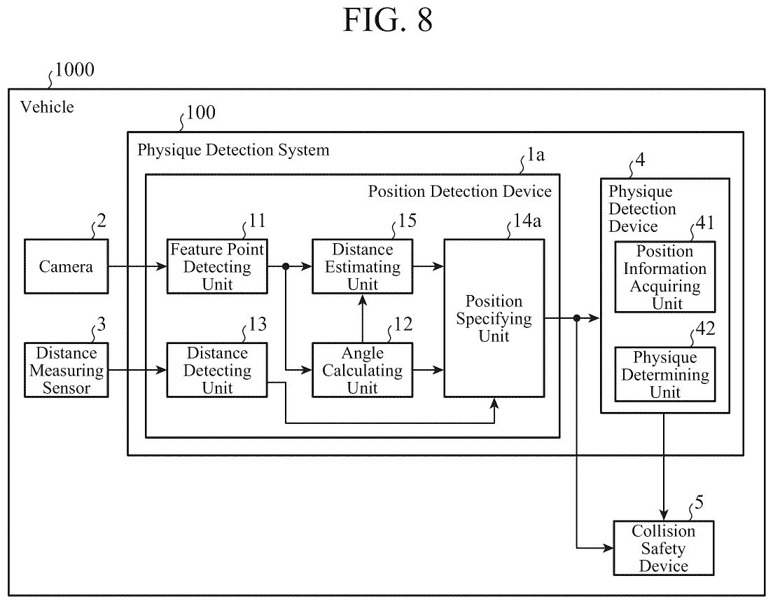

FIG. 8 is a diagram illustrating a configuration example of a position detection device 1a according to the second embodiment.

In the configuration example of the position detection device 1a illustrated in FIG. 8, components similar to those of the position detection device 1 according to the first embodiment described with reference to FIG. 1 in the first embodiment are denoted by the same reference numerals, and redundant description is omitted.

The position detection device 1a according to the second embodiment is different from the position detection device 1 according to the first embodiment described with reference to FIG. 1 in that a distance estimating unit 15 is provided.

In addition, in the position detection device 1a according to the second embodiment, a specific operation of a position specifying unit 14a is different from the specific operation of the position specifying unit 14 in the position detection device 1 according to the first embodiment.

The distance estimating unit 15 estimates a distance (hereinafter referred to as a “second distance”) from the camera 2 to the target feature point on the basis of a plurality of feature points detected by the feature point detecting unit 11.

Note that, in the second embodiment, the feature point detecting unit 11 detects a plurality of feature points. The feature point detecting unit 11 outputs information regarding the plurality of detected feature points to the distance estimating unit 15.

The distance estimating unit 15 is only required to estimate the second distance to the target feature point on the basis of a plurality of feature points detected from the captured image using a known technique represented by the technique disclosed in WO 2019/163124, for example.

For example, the distance estimating unit 15 calculates a distance (hereinafter referred to as a “distance between feature points”) between any two feature points (for example, a feature point corresponding to the right eye of the occupant and a feature point corresponding to the left eye of the occupant, hereinafter referred to as “feature points for distance calculation”) among a plurality of feature points. Note that the inter-feature point distance is a distance in a captured image, and the unit of the inter-feature point distance is a pixel (px). The distance estimating unit 15 can also calculate the inter-feature point distance in consideration of the face direction of the occupant (see, for example, WO 2019/163124).

The distance estimating unit 15 estimates the three-dimensional position of the target feature point of the occupant in a real space using, for example, a feature point position angle calculated by the angle calculating unit 12, an inter-feature point distance, and an inter-reference feature point distance (hereinafter referred to as a “first inter-reference feature point distance”) stored in advance in the distance estimating unit 15, and estimates the second distance. Note that the value of the first inter-reference feature point distance is set on the basis of, for example, statistics of actual measurement values for a plurality of persons. Specifically, for example, a width (for example, a width between both eyes) between regions corresponding to the feature points for distance calculation is actually measured for each of a plurality of persons. The distance estimating unit 15 stores in advance the average value of the measured widths as the value of the first inter-reference feature point distance.

The distance estimating unit 15 outputs information regarding the estimated second distance (hereinafter referred to as “camera distance information”) to the position specifying unit 14a.

The position specifying unit 14a determines the distance (hereinafter referred to as a “post-determination distance”) to the target feature point on the basis of the first distance detected by the distance detecting unit 13 and the second distance estimated by the distance estimating unit 15.

In the second embodiment, the post-determination distance is a distance to a more probable target feature point determined from the first distance and the second distance in consideration of the distance resolution of the radio wave sensor.

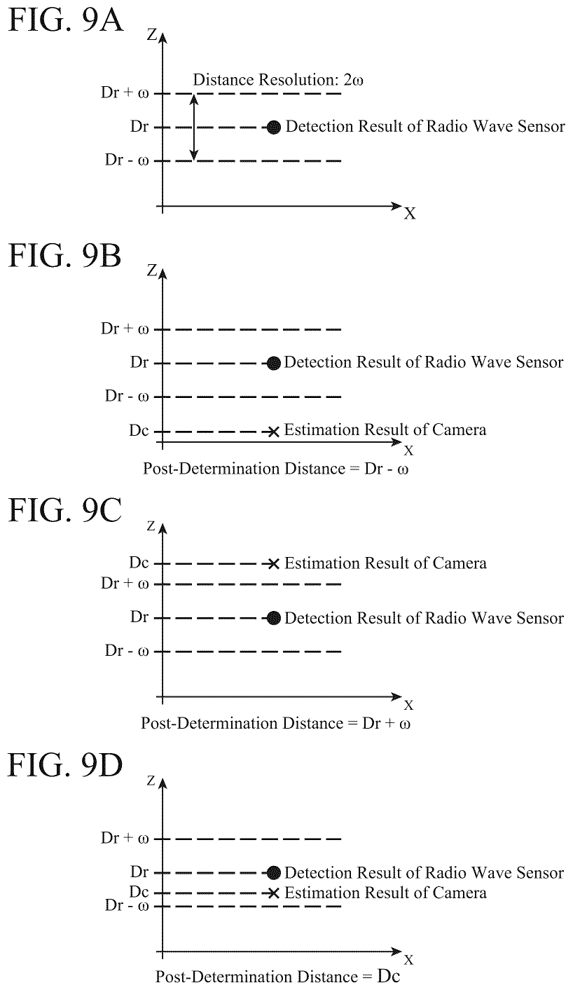

Here, FIG. 9 is a diagram for describing an example of a method for determining the post-determination distance by the position specifying unit 14a in the second embodiment. FIG. 9A is a diagram illustrating the relationship between a detection result of the radio wave sensor and the distance resolution, and FIGS. 9B, 9C, and 9D are diagrams illustrating post-determination distances determined by the position specifying unit 14a using the second distance.

Note that, in FIG. 9, the distance resolution of the radio wave sensor is “2ω”. Further, in FIG. 9, the value of the first distance detected by the distance detecting unit 13 on the basis of the sensor information that is the detection result of the radio wave sensor is Dr [m]. In FIG. 9, the first distance is indicated as “detection result of radio wave sensor”. Further, in FIG. 9, the value of the second distance estimated by the distance estimating unit 15 on the basis of the captured image of the camera 2 is denoted by Dc [m]. In FIG. 9, the second distance is indicated as “estimation result of camera”.

As illustrated in FIG. 9A, when the first distance detected by the radio wave sensor is an intermediate value of the distance resolution (=2ω), the value of an actual distance to the target feature point is any value between a “value obtained by subtracting half of the distance resolution from the first distance” and a “value obtained by adding half of the distance resolution to the first distance”. That is, when the first distance detected by the radio wave sensor is the intermediate value of the distance resolution (=2ω), the value of the actual distance to the target feature point is any value between Dr−ω and Dr+ω [m]. The position specifying unit 14a determines the post-determination distance between Dr−ω to Dr+ω [m] in consideration of the distance resolution of the radio wave sensor on the basis of the first distance and the second distance.

As illustrated in FIG. 9B, in a case where the value of the second distance is smaller than the value obtained by subtracting half of the distance resolution from the first distance, here, in a case where Dc [m] is smaller than Dr−ω [m], the position specifying unit 14a determines that the value of the post-determination distance is the “value obtained by subtracting half of the distance resolution from the first distance”. That is, the position specifying unit 14a determines the value of the post-determination distance as Dr−ω [m].

As illustrated in FIG. 9C, in a case where the value of the second distance is larger than the value obtained by adding half of the distance resolution to the first distance, here, in a case where Dc [m] is larger than Dr+ω [m], the position specifying unit 14a determines that the value of the post-determination distance is the “value obtained by adding half of the distance resolution to the first distance”. That is, the position specifying unit 14a determines the value of the post-determination distance as Dr+ω [m].

As illustrated in FIG. 9D, in a case where the value of the second distance is equal to or larger than the value obtained by subtracting half of the distance resolution from the first distance and equal to or smaller than the value obtained by adding half of the distance resolution to the first distance, here, in a case where Dc [m] is within the range of Dr−ω to Dr+ω [m], the position specifying unit 14a sets the value of the post-determination distance as the “value of the second distance”. That is, the position specifying unit 14a determines the value of the post-determination distance as Dc [m].

The process of determining the post-determination distance on the basis of the first distance and the second distance performed by the position specifying unit 14a as described with reference to FIG. 9 is referred to as “distance determination processing”.

Upon determining the post-determination distance, the position specifying unit 14a specifies the three-dimensional position of the occupant on the basis of the feature point position angle calculated by the angle calculating unit 12 and the post-determination distance.

Since a specific method of specifying the three-dimensional position of the occupant by the position specifying unit 14a has been described in the first embodiment, redundant description is omitted. In the first embodiment, the position specifying unit 14a specifies the three-dimensional position of the occupant on the basis of the first distance and the feature point position angle, but in the second embodiment, the position specifying unit 14a replaces the first distance with the post-determination distance to specify the three-dimensional position of the occupant.

The operation of the position detection device 1a according to the second embodiment will be described.

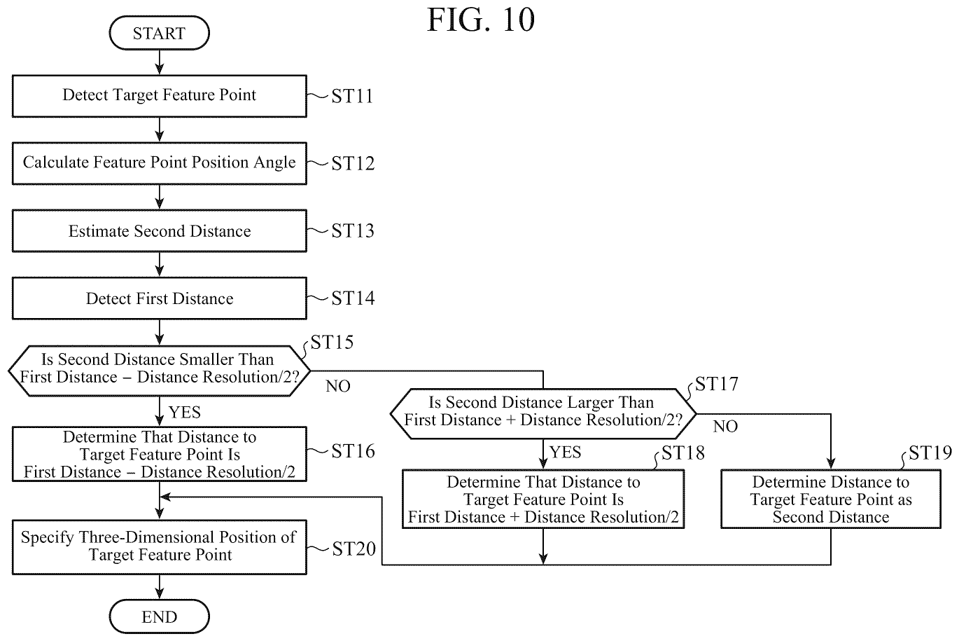

FIG. 10 is a flowchart for describing the operation of the position detection device 1a according to the second embodiment.

In the flowchart of FIG. 10, specific processing contents of steps ST11 to ST12 and step ST14 are similar to the specific processing contents of steps ST1 to ST3 of FIG. 6 described in the first embodiment, respectively, and thus redundant description is omitted.

The distance estimating unit 15 estimates the second distance on the basis of the plurality of feature points detected by the feature point detecting unit 11 in step ST11 (step ST13).

The distance estimating unit 15 outputs the camera distance information to the position specifying unit 14a.

The position specifying unit 14a executes the “distance determination processing” on the basis of the first distance detected by the distance detecting unit 13 in step ST14 and the second distance estimated by the distance estimating unit 15 in step ST13, and determines the post-determination distance.

Specifically, first, the position specifying unit 14a determines whether or not the value of the second distance is smaller than the value obtained by subtracting half of the distance resolution from the first distance (step ST15).

When the value of the second distance is smaller than the value obtained by subtracting half of the distance resolution from the first distance (“YES” in step ST15), the position specifying unit 14a determines that the value of the post-determination distance is the “value obtained by subtracting half of the distance resolution from the first distance” (step ST16). Then, the operation of the position detection device 1a proceeds to processing of step ST20.

When the value of the second distance is equal to or larger than the value obtained by subtracting half of the distance resolution from the first distance (“NO” in step ST15), the position specifying unit 14a determines whether or not the value of the second distance is larger than the value obtained by adding half of the distance resolution to the first distance (step ST17).

When the value of the second distance is larger than the value obtained by adding half of the distance resolution to the first distance (“YES” in step ST17), the position specifying unit 14a determines that the value of the post-determination distance is the “value obtained by adding half of the distance resolution to the first distance” (step ST18). Then, the operation of the position detection device 1a proceeds to processing of step ST20.

In a case where the value of the second distance is equal to or less than the value obtained by adding half of the distance resolution to the first distance (“NO” in step ST17), in other words, in a case where the value of the second distance is equal to or more than the value obtained by subtracting half of the distance resolution from the first distance and equal to or less than the value obtained by adding half of the distance resolution to the first distance, the position specifying unit 14a sets the value of the post-determination distance as the “value of the second distance” (step ST19). Then, the operation of the position detection device 1a proceeds to processing of step ST20.

The above processing from step ST15 to step ST19 is the “distance determination processing” performed by the position specifying unit 14a.

In step ST20, the position specifying unit 14a specifies the three-dimensional position of the target feature point on the basis of the feature point position angle calculated by the angle calculating unit 12 in step ST12 and the post-determination distance determined in step ST16, step ST18, or step ST19.

Note that, in the flowchart illustrated in FIG. 10, the position detection device 1a performs processing in the order of step ST11, step ST12, step ST13, and step ST14, but this is merely an example.

For example, the position detection device 1a may perform processing in the order of step ST14, step ST11, step ST12, and step ST13, or may perform the processing in steps ST11 to ST13 and the processing in step ST14 in parallel.

As described above, the position detection device 1a can determine the more probable distance (post-determination distance) to the target feature point with accuracy equal to or higher than the distance resolution of the radio wave sensor. Thus, the position detection device 1a can specify the three-dimensional position of the target feature point, in other words, the three-dimensional position of the occupant with higher accuracy than in a case where the distance resolution of the radio wave sensor is not considered.

The hardware configuration of the position detection device 1a according to the second embodiment is similar to the hardware configuration of the position detection device 1 according to the first embodiment described with reference to FIGS. 7A and 7B, and thus illustration is omitted.

In the second embodiment, the functions of the feature point detecting unit 11, the angle calculating unit 12, the distance detecting unit 13, the position specifying unit 14a, and the distance estimating unit 15 are implemented by the processing circuit 91. That is, the position detection device 1a includes the processing circuit 91 for performing control to detect the three-dimensional position of the person from the captured image captured by the camera 2 and the sensor information acquired by the radio wave sensor.

The processing circuit 91 executes the functions of the feature point detecting unit 11, the angle calculating unit 12, the distance detecting unit 13, the position specifying unit 14a, and the distance estimating unit 15 by reading and executing the program stored in the memory 95. That is, the position detection device 1a includes the memory 95 for storing a program that results in execution of steps ST11 to ST20 in FIG. 10 described above when executed by the processing circuit 91. Further, it can also be said that the program stored in the memory 95 causes a computer to execute a procedure or a method of processing performed in the feature point detecting unit 11, the angle calculating unit 12, the distance detecting unit 13, the position specifying unit 14a, and the distance estimating unit 15.

Furthermore, the position detection device 1a includes the input interface device 92 and the output interface device 93 that perform wired communication or wireless communication with a device such as the camera 2, the radio wave sensor, the physique detection device 4, or the collision safety device 5.

Note that, in the second embodiment described above, the position detection device 1a can also detect three-dimensional positions of a plurality of target feature points, similarly to the position detection device 1 according to the first embodiment.

Further, in the second embodiment, the position detection device 1a can also specify the three-dimensional position of the occupant in the back seat.

In addition, in the second embodiment described above, for example, a plurality of cameras 2 may be installed in the vehicle interior, and a plurality of distance measuring sensors 3 may be installed in the vehicle interior.

In addition, in the above-described second embodiment, an in-vehicle device and a server may constitute a position detection system in which a part of the feature point detecting unit 11, the angle calculating unit 12, the distance detecting unit 13, the position specifying unit 14a, and the distance estimating unit 15 is included in the in-vehicle device of the vehicle, and the rest is provided in the server connected to the in-vehicle device via a network.

In addition, all of the feature point detecting unit 11, the angle calculating unit 12, the distance detecting unit 13, the position specifying unit 14a, and the distance estimating unit 15 may be included in the server.

In addition, in the second embodiment described above, a part of the position information acquiring unit 41 and the physique determining unit 42 may be included in the in-vehicle device, others may be included in the server, or the position information acquiring unit 41 and the physique determining unit 42 may be included in the server. In addition, the collision safety device 5 may be provided in the server.

Further, in the second embodiment, the position detection device 1a can detect the three-dimensional position of the occupant in various vehicles. In addition, the position detection device 1a can detect the three-dimensional position of not only an occupant of a vehicle but also a person in a real space, such as a person in a room.

As described above, according to the second embodiment, the distance measuring sensor 3 is a radio wave sensor, in the position detection device 1a, the feature point detecting unit 11 detects a plurality of feature points including the target feature point, the position detection device 1a includes the distance estimating unit 15 to estimates a second distance from the camera 2 to the target feature point on the basis of the plurality of feature points detected by the feature point detecting unit 11, and the position specifying unit 14a is configured to determine a post-determination distance from the radio wave sensor to the target feature point on the basis of the first distance detected by the distance detecting unit 13 and the second distance estimated by the distance estimating unit 15, and specify the three-dimensional position of the target feature point on the basis of the feature point position angle calculated by the angle calculating unit 12 and the post-determination distance. Thus, the position detection device 1a can specify the three-dimensional position of the person with higher accuracy as compared with a case where the distance resolution of the radio wave sensor is not considered.

### Third Embodiment

In the second embodiment, the distance measuring sensor is a radio wave sensor, and the three-dimensional position of the person is specified with higher accuracy by considering the distance from the camera to the person estimated on the basis of the captured image.

In a third embodiment, a description will be further given of an embodiment in which it is determined whether or not to consider the distance from the camera to the person estimated on the basis of the captured image according to whether or not the person wears an attachment.

Also in the following third embodiment, as in the second embodiment, as an example, a person whose three-dimensional position is to be specified is an occupant sitting on a driver's seat or a passenger seat of a vehicle, and the position of the occupant is indicated by the position of the head of the occupant. In addition, it is assumed that the camera and the distance measuring sensor are installed at positions as described with reference to FIG. 3 in the first embodiment. Also in the third embodiment, as in the second embodiment, it is assumed that the distance measuring sensor is a radio wave sensor.

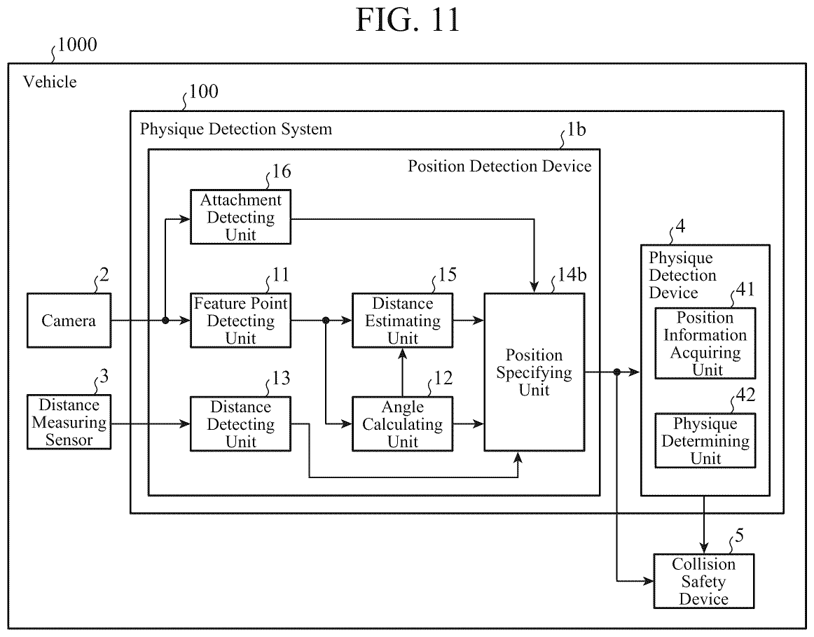

FIG. 11 is a diagram illustrating a configuration example of a position detection device 1b according to the third embodiment.

In the configuration example of the position detection device 1b illustrated in FIG. 11, components similar to those of the position detection device 1a according to the second embodiment described with reference to FIG. 8 in the second embodiment are denoted by the same reference numerals, and redundant description is omitted.

The position detection device 1b according to the third embodiment is different from the position detection device 1a according to the second embodiment described with reference to FIG. 8 in that the position detection device 1b includes an attachment detecting unit 16.

In addition, in the position detection device 1b according to the third embodiment, the specific operation of the position specifying unit 14b is different from the specific operation of the position specifying unit 14a in the position detection device 1a according to the second embodiment.

The attachment detecting unit 16 acquires a captured image from the camera 2, and detects an attachment worn by an occupant on the basis of the acquired captured image. In the third embodiment, the attachment is assumed to cover a feature point indicating a region of the body of the occupant, such as sunglasses or a mask.

The attachment detecting unit 16 may detect the attachment worn by the occupant using a known technique such as a known image recognition technology.

The attachment detecting unit 16 outputs information (hereinafter referred to as “attachment detection information”) indicating whether or not the attachment worn by the occupant is detected to the position specifying unit 14b.

When the attachment detecting unit 16 has detected the attachment worn by the occupant on the basis of the attachment detection information output from the attachment detecting unit 16, the position specifying unit 14b specifies the three-dimensional position of the target feature point on the basis of the feature point position angle calculated by the angle calculating unit 12 and the first distance detected by the distance detecting unit 13.

Note that a specific method by which the position specifying unit 14b specifies the three-dimensional position of the target feature point on the basis of the feature point position angle and the first distance is similar to the specific method by which the position specifying unit 14 specifies the three-dimensional position of the target feature point on the basis of the feature point position angle and the first distance in the first embodiment, and thus redundant description is omitted.

On the other hand, when the attachment detecting unit 16 does not detect the attachment worn by the occupant, the position specifying unit 14b executes the “distance determination processing” and determines the post-determination distance on the basis of the first distance detected by the distance detecting unit 13 and the second distance estimated by the distance estimating unit 15. Details of the “distance determination processing” have already been described in the second embodiment, and thus duplicate description is omitted. Then, the position specifying unit 14b specifies the three-dimensional position of the target feature point on the basis of the feature point position angle calculated by the angle calculating unit 12 and the post-determination distance.

Note that a specific method by which the position specifying unit 14b specifies the three-dimensional position of the target feature point on the basis of the feature point position angle and the post-determination distance is similar to the specific method by which the position specifying unit 14a specifies the three-dimensional position of the target feature point on the basis of the feature point position angle and the post-determination distance in the second embodiment, and thus redundant description is omitted.

The position specifying unit 14a of the position detection device 1a according to the second embodiment uniformly executes the “distance determination processing” on the first distance detected by the distance detecting unit 13 to determine the post-determination distance, and specifies the three-dimensional position of the target feature point from the post-determination distance and the feature point position angle.

However, in a case where the occupant wears the attachment object, the number of feature points detected by the feature point detecting unit 11 decreases. As a result, errors of the second distance estimated by the distance estimating unit 15 increase. Then, the “distance determination processing” is not appropriately executed in the position detection device 1a, and the value of the post-determination distance may be less probable than the value of the first distance.

Therefore, in the third embodiment, the position specifying unit 14b executes the “distance determination processing” only when the attachment worn by the occupant is not detected, in other words, when the occupant does not wear the attachment.

The operation of the position detection device 1b according to the third embodiment will be described.

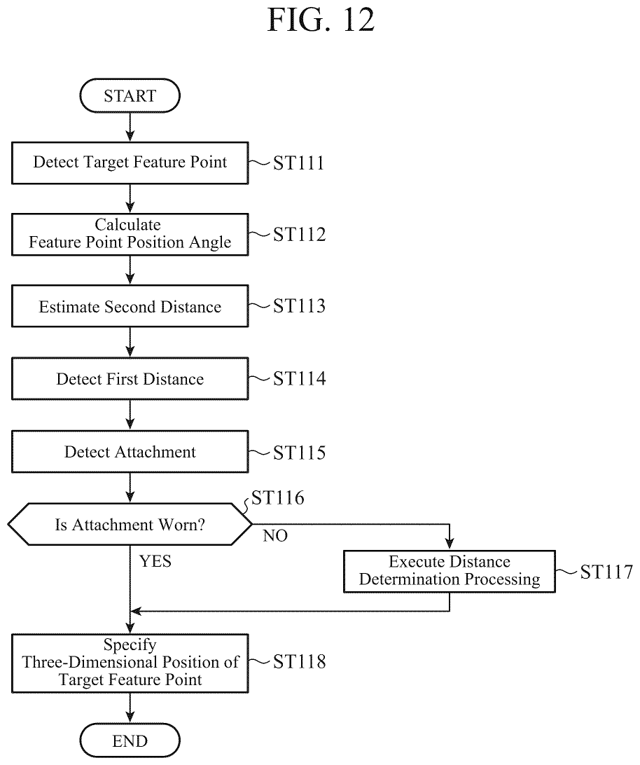

FIG. 12 is a flowchart for describing the operation of the position detection device 1b according to the third embodiment.

In the flowchart of FIG. 12, specific processing contents of steps ST111 to ST114 are similar to the specific processing contents of steps ST11 to ST14 of FIG. 10 described in the second embodiment, respectively, and thus redundant description is omitted.

The attachment detecting unit 16 acquires a captured image from the camera 2 and detects an attachment worn by the occupant on the basis of the acquired captured image (step ST115).

The attachment detecting unit 16 outputs the attachment detection information to the position specifying unit 14b.

The position specifying unit 14b determines whether the attachment detecting unit 16 has detected an attachment worn by the occupant on the basis of the attachment detection information output from the attachment detecting unit 16 in step ST115 (step ST116).

When the attachment detecting unit 16 detects the attachment worn by the occupant (“YES” in step ST116), the position specifying unit 14b specifies the three-dimensional position of the target feature point on the basis of the feature point position angle calculated by the angle calculating unit 12 in step ST112 and the first distance detected by the distance detecting unit 13 in step ST114 (step ST118).

On the other hand, when the attachment detecting unit 16 has not detect the attachment worn by the occupant (“NO” in step ST116), the position specifying unit 14b executes the “distance determination processing” and determines the post-determination distance (step ST117. See steps ST15 to ST19 in FIG. 10). Then, the position specifying unit 14b specifies the three-dimensional position of the target feature point on the basis of the feature point position angle calculated by the angle calculating unit 12 in step ST112 and the post-determination distance determined in step ST117 (step ST118).

Note that, in the flowchart illustrated in FIG. 12, the position detection device 1b performs processing in the order of step ST111, step ST112, step ST113, step ST114, and step ST115, but this is merely an example.

For example, the position detection device 1b may perform the processing of steps ST111 to ST113, the processing of step ST114, and the processing of step ST115 in parallel. In addition, the position detection device 1b may perform, for example, the processing of step ST114 or the processing of step ST115 before the processing of steps ST111 to ST113. Further, the position detection device 1b may perform the processing of step ST115 before the processing of step ST114.

As described above, using the distance (second distance) from the camera 2 to the target feature point estimated from the captured image, the position detection device 1b can determine the more probable distance (post-determination distance) to the target feature point with accuracy equal to or higher than the distance resolution of the radio wave sensor. On the other hand, the position detection device 1b does not determine the post-determination distance in a case where the occupant wears the attachment and it is assumed that an error is likely to occur in the second distance.

Thus, the position detection device 1b can specify the three-dimensional position of the target feature point, in other words, the three-dimensional position of the occupant with higher accuracy as compared with a case of not considering the occupant wearing the attachment.

The hardware configuration of the position detection device 1b according to the third embodiment is similar to the hardware configuration of the position detection device 1 according to the first embodiment described with reference to FIGS. 7A and 7B, and thus illustration is omitted.

In the third embodiment, the functions of the feature point detecting unit 11, the angle calculating unit 12, the distance detecting unit 13, the position specifying unit 14b, the distance estimating unit 15, and the attachment detecting unit 16 are implemented by the processing circuit 91. That is, the position detection device 1b includes the processing circuit 91 for performing control to detect the three-dimensional position of the person from the captured image captured by the camera 2 and the sensor information acquired by the radio wave sensor.

The processing circuit 91 reads and executes the program stored in the memory 95, thereby executing the functions of the feature point detecting unit 11, the angle calculating unit 12, the distance detecting unit 13, the position specifying unit 14b, the distance estimating unit 15, and the attachment detecting unit 16. That is, the position detection device 1b includes the memory 95 for storing a program that results in execution of steps ST111 to ST118 in FIG. 12 described above when executed by the processing circuit 91. Further, it can also be said that the program stored in the memory 95 causes a computer to execute a processing procedure or method of the feature point detecting unit 11, the angle calculating unit 12, the distance detecting unit 13, the position specifying unit 14b, the distance estimating unit 15, and the attachment detecting unit 16.

In addition, the position detection device 1b includes the input interface device 92 and the output interface device 93 that perform wired communication or wireless communication with a device such as the camera 2, the radio wave sensor, the physique detection device 4, or the collision safety device 5.

Note that, in the third embodiment described above, the position detection device 1b can also detect three-dimensional positions of a plurality of target feature points, similarly to the position detection device 1a according to the second embodiment.

In addition, in the third embodiment, the position detection device 1b can also specify the three-dimensional position of the occupant in the back seat.

In addition, in the third embodiment described above, for example, a plurality of cameras 2 may be installed in the vehicle interior, and a plurality of distance measuring sensors 3 may be installed in the vehicle interior.

In addition, in the above-described third embodiment, an in-vehicle device and a server may constitute a position detection system in which a part of the feature point detecting unit 11, the angle calculating unit 12, the distance detecting unit 13, the position specifying unit 14b, the distance estimating unit 15, and the attachment detecting unit 16 is included in the in-vehicle device of the vehicle, and the rest is provided in the server connected to the in-vehicle device via a network.

In addition, all of the feature point detecting unit 11, the angle calculating unit 12, the distance detecting unit 13, the position specifying unit 14b, the distance estimating unit 15, and the attachment detecting unit 16 may be provided in the server.

In addition, in the third embodiment described above, a part of the position information acquiring unit 41 and the physique determining unit 42 may be included in the in-vehicle device, others may be included in the server, or the position information acquiring unit 41 and the physique determining unit 42 may be included in the server. In addition, the collision safety device 5 may be provided in the server.

In the third embodiment, the position detection device 1b can detect the three-dimensional position of the occupant in various vehicles. In addition, the position detection device 1b can detect the three-dimensional position of not only an occupant of a vehicle but also a person in a real space, such as a person in a room.

As described above, according to the third embodiment, the position detection device 1b includes the attachment detecting unit 16 to detect an attachment worn by the person on the basis of the captured image, and the position specifying unit 14b is configured to specify the three-dimensional position of the target feature point on the basis of the feature point position angle and the first distance when the attachment detecting unit 16 detects the attachment, and specify the three-dimensional position of the target feature point on the basis of the feature point position angle and the post-determination distance when the attachment detecting unit 16 does not detect the attachment. Thus, when the position detection device 1b specifies the three-dimensional position of the person in consideration of the distance resolution of the radio wave sensor, the position detection device 1b can specify the three-dimensional position of the person with higher accuracy than a case where whether or not the person wears the attachment is not considered.

### Fourth Embodiment

In a fourth embodiment, a description will be given of an embodiment in which the inter-reference feature point distance used for estimating the distance from a camera to a person on the basis of a captured image is set using the first distance detected from sensor information.

Also in the following fourth embodiment, as in the second embodiment, as an example, a person whose three-dimensional position is to be specified is an occupant sitting on a driver's seat or a passenger seat of a vehicle, and the position of the occupant is indicated by the position of the head of the occupant. In addition, it is assumed that the camera and the distance measuring sensor are installed at positions as described with reference to FIG. 3 in the first embodiment.

Also in the fourth embodiment, as in the second embodiment, it is assumed that the distance measuring sensor is a radio wave sensor.

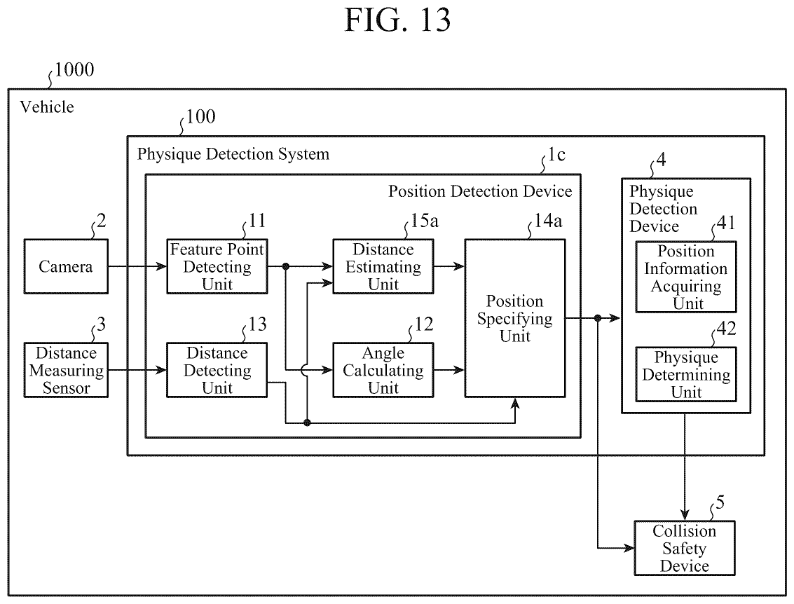

FIG. 13 is a diagram illustrating a configuration example of a position detection device 1c according to the fourth embodiment.

In the configuration example of the position detection device 1c illustrated in FIG. 13, components similar to those of the position detection device 1a according to the second embodiment described with reference to FIG. 8 in the second embodiment are denoted by the same reference numerals, and redundant description is omitted.

In the fourth embodiment, in the position detection device 1c, the specific operation of a distance estimating unit 15a is different from the specific operation of the distance estimating unit 15 in the position detection device 1a according to the second embodiment.

The distance estimating unit 15a estimates the second distance from the camera 2 to the target feature point on the basis of an inter-feature point distance, which is a distance between feature points for distance calculation among a plurality of feature points detected by the feature point detecting unit 11, and an inter-reference feature point distance (hereinafter referred to as a “second inter-reference feature point distance”). In the fourth embodiment, the second inter-reference feature point distance is set by the distance estimating unit 15a on the basis of the inter-feature point distance and the first distance detected by the distance detecting unit 13 before the distance estimating unit 15a estimates the second distance, and is stored in the distance estimating unit 15a.

Specifically, the distance estimating unit 15a first performs “processing of setting inter-reference feature point distance” for setting the second inter-reference feature point distance on the basis of the inter-feature point distance, which is a distance between feature points for distance calculation among a plurality of feature points detected by the feature point detecting unit 11, and the first distance detected by the distance detecting unit 13. Upon setting the second inter-reference feature point distance by performing the “processing of setting inter-reference feature point distance”, the distance estimating unit 15a stores the set second inter-reference feature point distance.

The “processing of setting inter-reference feature point distance” is performed before the distance estimating unit 15a estimates the second distance.

Then, after performing the “processing of setting inter-reference feature point distance”, the distance estimating unit 15a estimates the second distance from the camera 2 to the target feature point on the basis of the inter-feature point distance, which is the distance between the feature points for distance calculation among the plurality of feature points detected by the feature point detecting unit 11, and the stored second inter-reference feature point distance.

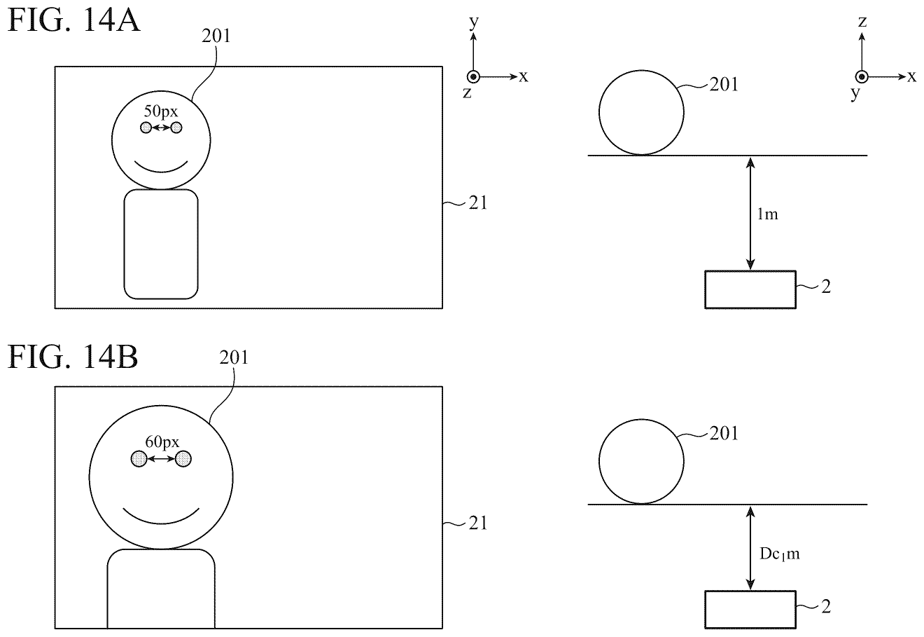

Here, FIGS. 14A and 14B are diagrams for describing an example of a method in which the distance estimating unit 15a sets the second inter-reference feature point distance and estimates the second distance using the set second inter-reference feature point distance in the fourth embodiment.

Here, the feature points for distance calculation are a feature point corresponding to the left eye of the occupant and a feature point corresponding to the right eye of the occupant, and the inter-feature point distance is a binocular distance.

FIG. 14A is a diagram for describing an example of the contents of the “processing of setting inter-reference feature point distance” performed by the distance estimating unit 15a, and FIG. 14B is a diagram for describing an example of a method in which the distance estimating unit 15a sets the second inter-reference feature point distance as illustrated in FIG. 14A and then estimates the second distance using the second inter-reference feature point distance.

The “processing of setting inter-reference feature point distance” by the distance estimating unit 15a will be described with reference to FIG. 14A.

For example, as illustrated in FIG. 14A, it is assumed that the distance estimating unit 15a calculates the inter-feature point distance, in other words, the binocular distance as 50 [px] from the captured image. In addition, it is assumed that the distance detecting unit 13 detects the first distance as 1 [m] on the basis of the sensor information.

In this case, the actual binocular distance [m] of the occupant is expressed by the following Expression (4).

Binocular distance [m]: second distance [m]=binocular distance [px]: focal length [px] of camera 2 (4)

Note that the value of the focal length of the camera 2 is stored in advance in the distance estimating unit 15a. Here, the focal length is set to f.

That is, in the example as illustrated in FIG. 14A, the binocular distance [m] is calculated as in the following Expression (5).

$$Binocular distance [ m ] : 1 [ m ] = 50 [ px ] : f [ px ] \qquad ( 5 )$$

$$Binocular distance [ m ] \times f [ px ] = 50 [ px ] \times 1 [ m ]$$

$$Binocular distance [ m ] = 50 / f [ m ]$$

The distance estimating unit 15a stores the calculated value of the binocular distance (50/f [m]) as the value of the second inter-reference feature point distance.

Note that the distance estimating unit 15a is only required to execute the “processing of setting inter-reference feature point distance” described with reference to FIG. 14A once, for example, while the vehicle 1000 is traveling.

In addition, for example, the distance estimating unit 15a may execute the “processing of setting inter-reference feature point distance” a plurality of times within a preset time, and set the average of the values of the second inter-reference feature point distance calculated in the processing of setting the respective second inter-reference feature point distance to the value of the second inter-reference feature point distance, or may set the value of the second inter-reference feature point distance by multiplying an update coefficient.

The distance estimating unit 15a sets the value of the second inter-reference feature point distance by multiplying the inter-reference feature point distance by the update coefficient and gradually updating the inter-reference feature point distance. For example, assuming that the update coefficient is 0.2, the distance estimating unit 15a updates the inter-reference feature point distance by 20%. As a specific example, for example, it is assumed that the inter-reference feature point distance is 50 mm and the second inter-reference feature point distance is 40 mm. In this case, the distance estimating unit 15a updates the inter-reference feature point distance by 2 mm corresponding to 20% of the difference 10 mm between the inter-reference feature point distance and the second inter-reference feature point distance, and sets 48 mm, which is the value of the updated inter-reference feature point distance, as the value of the distance between the second inter-reference feature point distance. The distance estimating unit 15a repeats such update processing, and sets the value of the second inter-reference feature point distance in stages.

Next, an example of a method in which the distance estimating unit 15a estimates the second distance using the second inter-reference feature point distance will be described with reference to FIG. 14B. Note that, here, it is assumed that “50/f [m]” is set to the value of the second inter-reference feature point distance, as in the above-described example.

After setting and storing the second inter-reference feature point distance, the distance estimating unit 15a estimates the second distance on the basis of the second inter-reference feature point distance and the inter-feature point distance, here, the binocular distance.

For example, as illustrated in FIG. 14B, it is assumed that the distance estimating unit 15a calculates the binocular distance as 60 [px] on the basis of the captured image.

Here, assuming that the second distance to be obtained is Dc₁ [m], the distance estimating unit 15a calculates Dc₁ [m] as follows from Expressions (4) and (5).

$$50 / f [ m ] : {Dc}_{1} [ m ] = 60 [ px ] : f [ px ]$$

$${Dc}_{1} [ m ] \times 60 [ px ] = 50 / f [ m ] \times f [ px ]$$

$${Dc}_{1} [ m ] = 50 / 60 = 0.83 [ m ]$$

As described above, in the example illustrated in FIG. 14B, the distance estimating unit 15a estimates the second distance to be 0.83 [m].

The distance estimating unit 15a outputs the camera distance information regarding the estimated second distance to the position specifying unit 14a.

The operation of the position detection device 1c according to the fourth embodiment will be described.

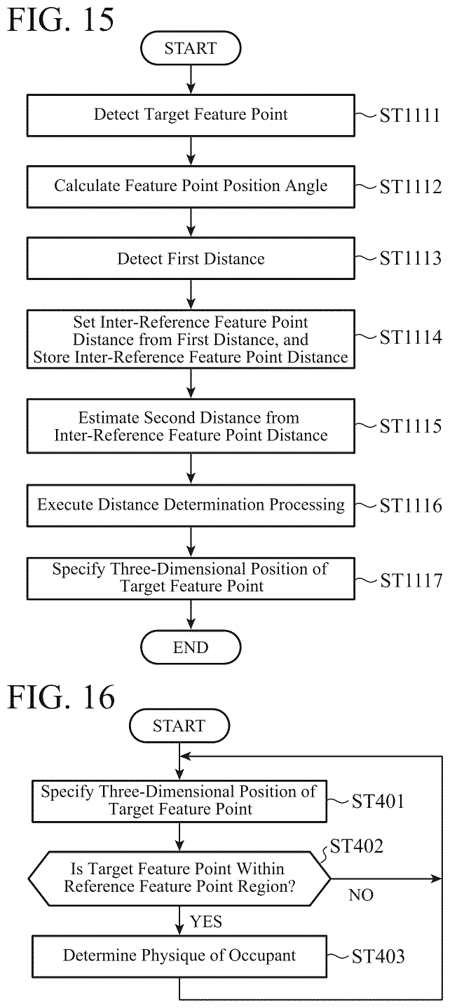

FIG. 15 is a flowchart for describing the operation of the position detection device 1c according to the fourth embodiment.

In the flowchart of FIG. 15, specific processing contents of steps ST1111 to ST1113 and step ST1117 are similar to the specific processing contents of steps ST11 to ST12, step ST14, and step ST20 of FIG. 10 described in the second embodiment, respectively, and thus redundant description is omitted.

In addition, in the flowchart of FIG. 15, the specific processing content of step ST1116 is similar to the specific processing content of steps ST15 to ST19 of FIG. 10 described in the second embodiment, and thus redundant description is omitted.

The distance estimating unit 15a performs “processing of setting inter-reference feature point distance” for setting the second inter-reference feature point distance on the basis of the inter-feature point distance, which is a distance between feature points for distance calculation among a plurality of feature points detected by the feature point detecting unit 11 in step ST1111, and the first distance detected by the distance detecting unit 13 in step ST1113, and sets the second inter-reference feature point distance (step ST1114). Then, the distance estimating unit 15a stores the set second inter-reference feature point distance.

After setting and storing the second inter-reference feature point distance in step ST1114, the distance estimating unit 15a estimates the second distance from the camera 2 to the target feature point on the basis of the inter-feature point distance, which is a distance between feature points for distance calculation among the plurality of feature points detected by the feature point detecting unit 11 in step ST1111, and the stored second inter-reference feature point distance (step ST1115).

Note that after the distance estimating unit 15a sets and stores the second inter-reference feature point distance, the position detection device 1c can omit the processing of step ST1114.

Furthermore, in the flowchart illustrated in FIG. 15, the position detection device 1c performs processing in the order of step ST1111, step ST1112, and step ST1113, but this is merely an example.

For example, the position detection device 1c may perform the processing in the order of step ST1113, step ST1111, and step ST1112, or may perform the processing in steps ST1111 to ST1112 and the processing in step ST1113 in parallel.

As described above, the position detection device 1c sets the second inter-reference feature point distance used when estimating the second distance from the camera 2 to the target feature point on the basis of the captured image using the sensor information acquired from the radio wave sensor.

When the value of the second inter-reference feature point distance is a value set without considering individual differences such as age and face shape, an error may occur in the second distance estimated by the distance estimating unit 15a. On the other hand, the position detection device 1c can estimate the second distance with high accuracy in consideration of individual differences such as age and face shape.

Consequently, when the position detection device 1c specifies the three-dimensional position of the occupant in consideration of the distance resolution of the radio wave sensor, the position detection device 1c can specify the three-dimensional position of the target feature point, in other words, the three-dimensional position of the occupant with higher accuracy.

The hardware configuration of the position detection device 1c according to the fourth embodiment is similar to the hardware configuration of the position detection device 1 according to the first embodiment described with reference to FIGS. 7A and 7B, and thus illustration is omitted.

In the fourth embodiment, the functions of the feature point detecting unit 11, the angle calculating unit 12, the distance detecting unit 13, the position specifying unit 14a, and the distance estimating unit 15a are implemented by the processing circuit 91. That is, the position detection device 1c includes the processing circuit 91 for performing control to detect the three-dimensional position of the person from the captured image captured by the camera 2 and the sensor information acquired by the radio wave sensor.

The processing circuit 91 executes the functions of the feature point detecting unit 11, the angle calculating unit 12, the distance detecting unit 13, the position specifying unit 14a, and the distance estimating unit 15a by reading and executing the program stored in the memory 95. That is, the position detection device 1c includes the memory 95 for storing a program that results in execution of steps ST1111 to ST117 in FIG. 15 described above when executed by the processing circuit 91. Further, it can also be said that the program stored in the memory 95 causes a computer to execute a procedure or a method of processing performed in the feature point detecting unit 11, the angle calculating unit 12, the distance detecting unit 13, the position specifying unit 14a, and the distance estimating unit 15a.

In addition, the position detection device 1c includes the input interface device 92 and the output interface device 93 that perform wired communication or wireless communication with a device such as the camera 2, the radio wave sensor, the physique detection device 4, or the collision safety device 5.

Note that, in the above-described fourth embodiment, the position detection device 1c can also detect three-dimensional positions of a plurality of target feature points, similarly to the position detection device 1a according to the second embodiment.

In the fourth embodiment, the position detection device 1c can also specify the three-dimensional position of the occupant in the back seat.

In addition, in the fourth embodiment described above, for example, a plurality of cameras 2 may be installed in the vehicle interior, and a plurality of distance measuring sensors 3 may be installed in the vehicle interior.

In addition, in the above-described fourth embodiment, an in-vehicle device and a server may constitute a position detection system in which a part of the feature point detecting unit 11, the angle calculating unit 12, the distance detecting unit 13, the position specifying unit 14a, and the distance estimating unit 15a is included in the in-vehicle device of the vehicle, and the rest is provided in the server connected to the in-vehicle device via a network.

In addition, all of the feature point detecting unit 11, the angle calculating unit 12, the distance detecting unit 13, the position specifying unit 14a, and the distance estimating unit 15a may be included in the server.

In addition, in the above-described fourth embodiment, a part of the position information acquiring unit 41 and the physique determining unit 42 may be included in the in-vehicle device, others may be included in the server, or the position information acquiring unit 41 and the physique determining unit 42 may be included in the server. In addition, the collision safety device 5 may be provided in the server.

In the fourth embodiment, the position detection device 1c can detect the three-dimensional position of the occupant in various vehicles. In addition, the position detection device 1c can detect the three-dimensional position of not only an occupant of a vehicle but also a person in a real space, such as a person in a room.

As described above, according to the fourth embodiment, in the position detection device 1c, the distance estimating unit 15a is configured to estimate the second distance from the camera 2 to the target feature point on the basis of the inter-feature point distance, which is a distance between the feature points for distance calculation among the plurality of feature points detected by the feature point detecting unit 11, and the inter-reference feature point distance (second inter-reference feature point distance), and the inter-reference feature point distance is set on the basis of the inter-feature point distance and the first distance detected by the distance detecting unit 13. Thus, the position detection device 1c can estimate the second distance with high accuracy in consideration of individual differences such as age and face shape. As a result, the position detection device 1c can specify the three-dimensional position of the occupant with higher accuracy when specifying the three-dimensional position of the occupant in consideration of the distance resolution of the radio wave sensor.

In the physique detection system 100 according to the first to fourth embodiments described above, the physique detection device 4 may determine whether or not the occupant is in a normal sitting state, and perform the physique determination when determining that the occupant is in the normal sitting state.

In the first to fourth embodiments, the “normal sitting state” refers to a state in which a person's posture is not lost.

Hereinafter, details of the physique detection device 4 configured to perform the physique determination when it is determined that the occupant is in the normal sitting state in the first to fourth embodiments will be described.

In the physique detection device 4, the physique determining unit 42 determines whether the three-dimensional position of the target feature point specified by the position specifying units 14, 14a, and 14b in the position detection devices 1, 1a, 1b, and 1c is within a reference feature point region. Note that the physique determining unit 42 can specify the three-dimensional position of the target feature point specified by the position specifying units 14, 14a, and 14b from the position information acquired by the position information acquiring unit 41.

In the first to fourth embodiments, the “reference feature point region” is a region in a real space in which the target feature point is assumed to be present when the occupant is in the normal sitting state.

In the reference feature point region, for example, in a state where a plurality of persons having various different physiques is normally seated, a region including all positions where target feature points of the plurality of persons are present is set in advance, and the physique determining unit 42 stores information regarding the reference feature point region.

When determining that the three-dimensional position of the target feature point specified by the position specifying units 14, 14a, and 14b is within the reference feature point region, the physique determining unit 42 determines the physique of the occupant.

On the other hand, when determining that the three-dimensional position of the target feature point specified by the position specifying units 14, 14a, and 14b is not within the reference feature point region, the physique determining unit 42 does not determine the physique of the occupant.

When the physique of the occupant is determined by the physique detection device 4, there is a possibility that the physique of the occupant is erroneously determined unless the occupant is in the normal sitting state.

The physique detection device 4 can reduce erroneous determination of the physique of the occupant by determining whether or not the occupant is in the normal sitting state and performing the physique determination of the occupant when determining that the occupant is in the normal sitting state.

FIG. 16 is a flowchart for describing the operation of the physique detection device 4 in a case where the physique determination is performed when it is determined that the occupant is in the normal sitting state in the physique detection system 100 according to the first embodiment to the fourth embodiment.

The position information acquiring unit 41 acquires position information from the position detection device 1 (step ST401).

The physique determining unit 42 determines whether or not the three-dimensional position of the target feature point specified by the position specifying unit 14, 14a, or 14b in the position detection device 1, 1a, 1b, or 1c is within the reference feature point region on the basis of the position information acquired by the position information acquiring unit 41 in step ST401 (step ST402).

When it is determined in step ST402 that the three-dimensional position of the target feature point specified by the position specifying unit 14, 14a, or 14b is within the reference feature point region (“YES” in step ST402), the physique determining unit 42 determines the physique of the occupant (step ST403).

When it is determined in step ST402 that the three-dimensional position of the target feature point specified by the position specifying unit 14, 14a, or 14b is not within the reference feature point region (“NO” in step ST402), the operation of the physique detection device 4 returns to the processing of step ST401.

As described above, in the physique detection device 4 of the physique detection system 100 according to the first embodiment to the fourth embodiment, the physique determining unit 42 may perform the physique determination of the occupant in a case where the three-dimensional position of the target feature point specified by the position specifying unit 14, 14a, or 14b of the position detection device 1, 1a, 1b, or 1c is within the reference feature point region in the real space in which the target feature point is assumed to be present when the occupant is in the normal sitting state.

Thus, in the physique detection system 100, the physique detection device 4 can reduce erroneous determination of the physique of the occupant.

An example of the hardware configuration of the physique detection device 4 according to the first to fourth embodiments is similar to the example of the hardware configuration of the position detection devices 1, 1a, 1b, and 1c illustrated in FIGS. 7A and 7B, and thus illustration is omitted.

In the first to fourth embodiments, the functions of the position information acquiring unit 41 and the physique determining unit 42 are implemented by the processing circuit 91. That is, the physique detection device 4 includes the processing circuit 91 for determining the physique of the occupant on the basis of the three-dimensional position of the occupant specified by the position detection devices 1, 1a, 1b, and 1c.

The processing circuit 91 may be dedicated hardware as illustrated in FIG. 7A or the processor 94 that executes the program stored in the memory as illustrated in FIG. 7B.

In a case where the processing circuit 91 is dedicated hardware, the processing circuit 91 corresponds to, for example, a single circuit, a composite circuit, a programmed processor, a parallel programmed processor, an application specific integrated circuit (ASIC), a field-programmable gate array (FPGA), or a combination thereof.

When the processing circuit is the processor 94, the functions of the position information acquiring unit 41 and the physique determining unit 42 are implemented by software, firmware, or a combination of software and firmware. The software or firmware is described as a program and stored in the memory 95. The processor 94 executes the functions of the position information acquiring unit 41 and the physique determining unit 42 by reading and executing the program stored in the memory 95. That is, the physique detection device 4 includes the memory 95 for storing a program that results in execution of processing such as steps ST1 to ST4 in FIG. 16 described above when executed by the processor 94. Further, it can also be said that the program stored in the memory 95 causes a computer to execute the procedures or methods of the position information acquiring unit 41 and the physique determining unit 42. Here, the memory 95 corresponds to, for example, a nonvolatile or volatile semiconductor memory such as a RAM, a read only memory (ROM), a flash memory, an erasable programmable read only memory (EPROM), or an electrically erasable programmable read-only memory (EEPROM), or a magnetic disk, a flexible disk, an optical disk, a compact disk, a mini disk, a digital versatile disc (DVD), or the like.

Note that a part of the functions of the position information acquiring unit 41 and the physique determining unit 42 may be implemented by dedicated hardware, and a part thereof may be implemented by software or firmware. For example, the function of the position information acquiring unit 41 can be implemented by the processing circuit 91 as dedicated hardware, and the function of the physique determining unit 42 can be implemented by the processor 94 reading and executing a program stored in the memory 95.

In addition, the physique detection device 4 includes the input interface device 92 and the output interface device 93 that perform wired communication or wireless communication with devices such as the position detection devices 1, 1a, 1b, and 1c or the collision safety device 5.

Note that, in the first to fourth embodiments, the physique detection device 4 can determine the physiques of not only the occupants of the vehicle 1000 but also occupants of various vehicles or people present in the real space on the basis of the position information regarding the three-dimensional positions of persons detected by the position detection devices 1, 1a, 1b, and 1c.

Note that, in the present disclosure, free combinations of the embodiments, modifications of any components of the embodiments, or omissions of any components in the embodiments are possible.

### INDUSTRIAL APPLICABILITY

The position detection device according to the present disclosure can specify the three-dimensional position of each individual person without executing a personal authentication process on any person.

### REFERENCE SIGNS LIST

1, 1a, 1b, 1c: position detection device, 2: camera, 3: distance measuring sensor, 4: physique detection device, 5: collision safety device, 11: feature point detecting unit, 12: angle calculating unit, 13: distance detecting unit, 14, 14a, 14b: position specifying unit, 15, 15a: distance estimating unit, 16: attachment detecting unit, 41: position information acquiring unit, 42: physique determining unit, 100: physique detection system, 1000: vehicle, 91: processing circuit, 92: input interface device, 93: output interface device, 94: processor, 95: memory

1. A position detection device, comprising:
processing circuitry configured to
detect, on a basis of a captured image captured by a camera, a target feature point corresponding to a part of a body of a person in the captured image;
calculate, on a basis of a position of the target feature point on the captured image having been detected, a feature point position angle indicating an angle of a straight line connecting the camera and the target feature point with respect to an imaging axis of the camera;
detect a first distance from a distance measuring sensor to the target feature point on a basis of sensor information acquired by the distance measuring sensor; and
specify a three-dimensional position of the target feature point on a basis of the calculated feature point position angle and the detected first distance.

2. The position detection device according to claim 1, wherein:
the distance measuring sensor is a radio wave sensor, and
the processing circuitry is further configured to:
detect a plurality of feature points including the target feature point;
estimate a second distance from the camera to the target feature point on a basis of the plurality of feature points having been detected, and
determine a post-determination distance from the radio wave sensor to the target feature point on a basis of the detected first distance and the estimated second distance, and specifies the three-dimensional position of the target feature point on a basis of the calculated feature point position angle and the post-determination distance.

3. The position detection device according to claim 2, wherein the processing circuitry is further configured to:
detect an attachment worn by the person on a basis of the captured image;
specify the three-dimensional position of the target feature point on a basis of the feature point position angle and the first distance when the attachment is detected; and
specify the three-dimensional position of the target feature point on a basis of the feature point position angle and the post-determination distance when the attachment is not detected.

4. The position detection device according to claim 2, wherein:
the processing circuitry estimates the second distance from the camera to the target feature point on a basis of an inter-feature point distance, which is a distance between feature points for distance calculation among the plurality of feature points having been detected, and an inter-reference feature point distance, and
the inter-reference feature point distance is set on a basis of the inter-feature point distance and the detected first distance.

5. The position detection device according to claim 1, wherein:
the processing circuitry detects the target feature point on a basis of the captured image captured by the camera installed with at least one of a lateral position, a height position, a depth position, or an installation inclination in a three-dimensional space being identical to a lateral position, a height position, a depth position, or an installation inclination of the distance measurement sensor and installed in a direction in which it is possible to image a real space in which the target feature point is assumed to be present, and
the processing circuitry detects the first distance on a basis of the sensor information sensed by the distance measuring sensor installed in a direction in which at least one of a lateral position, a height position, a depth position, or an installation inclination in a three-dimensional space being identical to a lateral position, a height position, a depth position, or an installation inclination of the camera and installed in a direction in which it is possible to sense a real space in which the target feature point is assumed to be present.

6. A physique detection system, comprising:
the position detection device according to claim 1;
a processor configured to
acquire position information regarding the specified three-dimensional position of the target feature point; and
determine a physique of the person on a basis of the position information acquired by the position information acquiring unit; and
determine the physique of the person in a case where the specified three-dimensional position of the target feature point is within a reference feature point region in a real space in which the target feature point is assumed to be present when person is in a normal sitting state.

7. A position detection method, comprising:
detecting on a basis of a captured image captured by a camera, a target feature point corresponding to a part of a body of a person in the captured image;
calculating on a basis of a position of the target feature point on the captured image having been detected, a feature point position angle indicating an angle of a straight line connecting the camera and the target feature point with respect to an imaging axis of the camera;
detecting a first distance from a distance measuring sensor to the target feature point on a basis of sensor information acquired by the distance measuring sensor; and
specifying a three-dimensional position of the target feature point on a basis of the calculated feature point position angle and the detected first distance.
